(19) United States
(12) Patent Application Publication
(10) Pub. No.: US 2019/0237272 A1
(43) Pub. Date: Aug. 1, 2019

(54) ELECTRODE STACKING DEVICE

(71) Applicant: KABUSHIKI KAISHA TOYOTA JIDOSHOKKI, Kariya-shi, Aichi (JP)

(72) Inventors: Hiroyasu NISHIHARA, Kariya-shi, Aichi (JP); Takuya MURATA, Kariya-shi (JP); Hayato SAKURAI, Kariya-shi (JP)

(73) Assignee: KABUSHIKI KAISHA TOYOTA JIDOSHOKKI, Kariya-shi, Aichi (JP)

(21) Appl. No.: 16/311,343

(22) PCT Filed: Jun. 19, 2017
(86) PCT No.: PCT/JP2017/022558

§ 371 Date: Dec. 19, 2018

(30) Foreign Application Priority Data
Jun. 20, 2016 (JP) 2016-121710

(51) Int. Cl. H01G 11/86; H01G 11/22; H01G 13/00; H01M 10/04

(52) U.S. Cl. CPC H01G 11/86; H01M 10/0404; H01G 13/00; H01G 11/22

(57) ABSTRACT

An electrode stacking device is an electrode stacking device for stacking electrodes supplied by a conveying device and forming an electrode stacked body, including an electrode support that receives the electrodes supplied by the conveying device and supports the electrodes, a mounting member to which a plurality of electrode supports is attached, a stacked unit having stacked portions of a plurality of levels on which the electrodes are stacked, and a discharge portion that discharges the electrodes supported by the plurality of electrode supports toward the stacked portions of the plurality of levels, in which the discharge portion discharges the electrodes at one interval with respect to the electrode supports per n levels (where n is an integer of 2 or more).

### TECHNICAL FIELD

The present invention relates to an electrode stacking device.

### BACKGROUND ART

For example, in a power storage device having a stacked electrode assembly such as a lithium ion secondary battery, an electrode stacking device for stacking electrodes is used. Here, for example, a device disclosed in Patent Literature 1 has been known as a stacking device that can perform high-speed stacking. Patent Literature 1 has a configuration in which processes or treatments which are difficult to shorten time are arranged in parallel to speed up a production line. For example, a piling apparatus described in Patent Literature 1 sorts materials to be cut into four upper and lower branch conveyors, decelerates the sorted materials to be cut on a deceleration conveyor, and then piles the materials in a piling room partitioned into four levels.

### CITATION LIST

### Patent Literature

Patent Literature 1: Japanese Unexamined Patent Publication No. S59-39653

### SUMMARY OF INVENTION

### Technical Problem

In the case of applying the configuration described in Patent Literature 1 to the electrode stacking device, when a workpiece conveyed at high speed is rapidly decelerated, a position shift of the workpiece occurs in a direction etc. of rotation of the workpiece on a conveying device. To prevent such a position shift from occurring, a distance for decelerating the workpiece needs to be ensured. In addition, when a conveyor constituting a conveyance path is multi-staged, space in a vertical direction is also required. As described above, in the electrode stacking device to which the configuration of Patent Literature 1 is applied, miniaturization of the device is difficult, and an increase in size of the device is inevitable. As a result, space required for installing the device also becomes large.

An object of the invention is to provide an electrode stacking device capable of achieving a high stacking speed while suppressing an increase in size of the device.

### Solution to Problem

An electrode stacking device according to an aspect of the invention is an electrode stacking device for stacking electrodes supplied by a conveying device and forming an electrode stacked body, including an electrode support that receives the electrodes supplied by the conveying device and supports the electrodes, a mounting member to which a plurality of electrode supports is attached, a stacked unit having stacked portions of a plurality of levels on which the electrodes are stacked, and a discharge portion that discharges the electrodes supported by the plurality of electrode supports toward the stacked portions of the plurality of levels, in which the discharge portion discharges the electrodes at one interval with respect to the electrode supports per n levels (where n is an integer of 2 or more).

In such an electrode stacking device, the electrodes successively supplied to the electrode supports are discharged to different stacked portions and stacked thereon. In this way, when electrodes, the number of which is larger than the number of successively supplied electrodes, are discharged and stacked, a discharge speed at the time of discharging the electrodes to the stacked portions may be set to be lower than a conveying speed (supply speed) of the electrodes by the conveying device. In this way, it is possible to suppress a position shift of the electrodes during stacking of the electrodes without providing an additional device while preventing a decrease in pace at which the electrodes are stacked. Here, the discharge portion discharges electrodes at one interval with respect to the electrode supports per n levels. As described above, the discharge portion may discharge the electrodes to the plurality of electrode supports by skipping (n−1) levels. In this way, while an interval at which the electrode supports receive the electrodes may be shortened by reducing a pitch of the electrode supports, the respective electrodes may be accurately discharged to the stacked portions in a state in which a sufficient space is ensured between the discharged electrodes on the stacked portion side. In this way, it is possible to further increase the stacking speed while ensuring the stacking accuracy. As described above, according to the electrode stacking device, it is possible to achieve a high stacking speed while suppressing an increase in size of the device.

The stacked unit nay have the stacked portions at one interval with respect to the electrode supports per n levels. In this case, it is possible to accurately receive an electrode by a stacked portion corresponding to an interval between electrodes discharged by the discharge portion.

The mounting member may correspond to a circulating member having an outer peripheral, surface to which the plurality of electrode supports is attached, the electrode stacking device may further include a control unit that controls circulation of the circulating member and an operation of the discharge portion, and the control unit may execute a first discharge operation of discharging m electrodes among the electrodes supported by the electrode supports using the discharge portion, a first movement operation of moving the circulating member with respect to the discharge portion in a circulation direction by one level of the electrode supports, and a second discharge operation of discharging m electrodes using the discharge portion after the first movement operation, and execute a second movement operation of moving the circulating member with respect to the discharge portion in the circulation direction by {m×n−(n−1)} levels of the electrode supports after executing the first movement operation and the second discharge operation (n−1) times. In this way, it is possible to smoothly interlock discharge by the discharge portion with circulation of the circulating member.

A pair of conveying units, each of which includes the electrode support, the mounting member, and the discharge portion, may be provided with the stacked unit interposed therebetween, one of the conveying units may convey a positive electrode obtained by forming a positive electrode active material layer on a surface of a positive electrode current collector, and the other one of the conveying units may convey a negative electrode obtained by forming a negative electrode active material layer on a surface of a negative electrode current collector. In this way, when the conveying units are adopted on both the positive electrode side and the negative electrode side, it is possible to achieve a higher stacking speed of the positive electrode and the negative electrode.

### Advantageous Effects of Invention

The invention provides an electrode stacking device capable of achieving a high stacking speed while suppressing an increase in size of the device.

### BRIEF DESCRIPTION OF DRAWINGS

FIG. 1 is a cross-sectional view illustrating an interior of a power storage device manufactured by applying an electrode stacking device according to an embodiment of the invention.

FIG. 2 is a cross-sectional view taken along II-II line of FIG. 1.

FIG. 3 is a side view (including partial cross section) illustrating the electrode stacking device according to the embodiment of the invention.

FIG. 4 is a diagram illustrating a configuration of a support.

FIG. 5 is a plan view of the electrode stacking device.

FIG. 6 is a diagram for description of an example of an operation of the electrode stacking device.

FIG. 7 is a diagram for description of an example of an operation of the electrode stacking device.

FIG. 8 is a diagram for description of action/effect of the electrode stacking device.

FIG. 9 is a flowchart illustrating a control flow of a circulating member.

FIG. 10 is a partial side view for description of an operation of the circulating member during a preparatory operation.

FIG. 11 is a partial side view for description of an operation of the circulating member during a stacking operation.

FIG. 12 is a partial side view for description of an operation of the circulating member during a return operation.

FIG. 13 is a flowchart illustrating a control flow of a positioning unit.

FIG. 14 is a flowchart illustrating a control flow of an extrusion unit on a positive electrode supply side.

FIG. 15 is a flowchart illustrating a control flow of an extrusion unit on a negative electrode supply side.

FIG. 16 is a diagram illustrating a configuration example of a support structure and a drive mechanism of a circulating member of a positive electrode conveying unit.

FIG. 17 is a diagram illustrating a configuration example of a support structure and a drive mechanism of the circulating member of the positive electrode conveying unit.

FIG. 18 is a diagram illustrating a first operation example of the circulating member.

FIG. 19 is a diagram illustrating a second operation example of the circulating member.

FIG. 20 is a diagram illustrating a third operation example of the circulating member.

FIG. 21 is a side view illustrating an electrode stacking device according to a modification.

FIG. 22 is a side view illustrating an electrode stacking device according to a modification.

FIG. 23 is a side view illustrating an electrode stacking device according to a modification.

FIG. 24 is a side view for description of an operation of an electrode stacking device according to a modification.

FIG. 25 is a side view for description of an operation of the electrode stacking device according to the modification.

FIG. 26 is a side view for description of an operation of the electrode stacking device according to the modification.

FIG. 27 is a side view for description of an operation of the electrode stacking device according to the modification.

FIG. 28 is a side view for description of an operation of the electrode stacking device according to the modification.

FIG. 29 is a side view for description of an operation of the electrode stacking device according to the modification.

FIG. 30 is a side view illustrating a discharge portion of the electrode stacking device according to the modification.

FIG. 31 is a side view illustrating an electrode stacking device according to a modification.

FIG. 32 is a plan view of the electrode stacking device according to the modification.

FIG. 33 is an enlarged view illustrating a part around a stacked portion of the electrode stacking device illustrated in FIG. 31.

### DESCRIPTION OF EMBODIMENTS

Hereinafter, an embodiment of the invention will be described in detail with reference to drawings. In the drawings, the same reference symbol will be assigned to the same or an equivalent element, and a repeated description will be omitted.

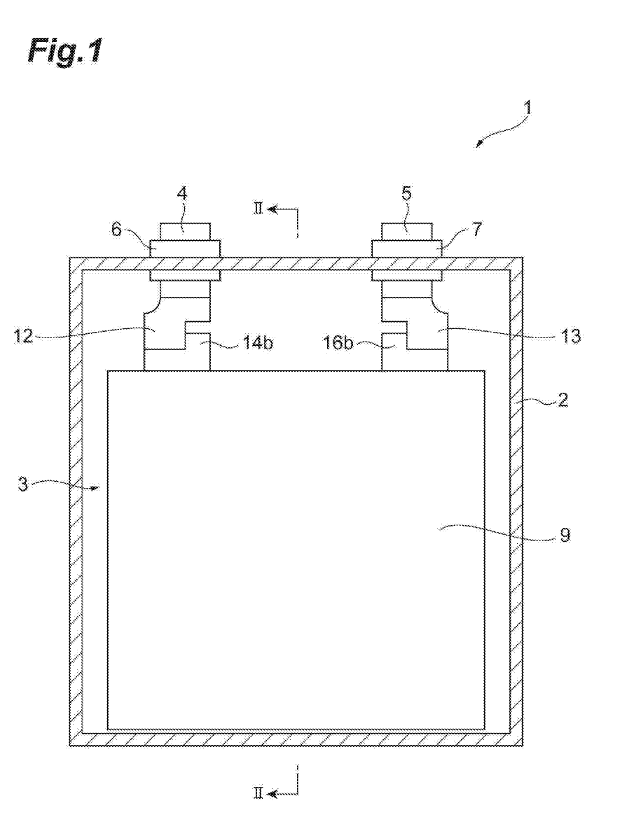

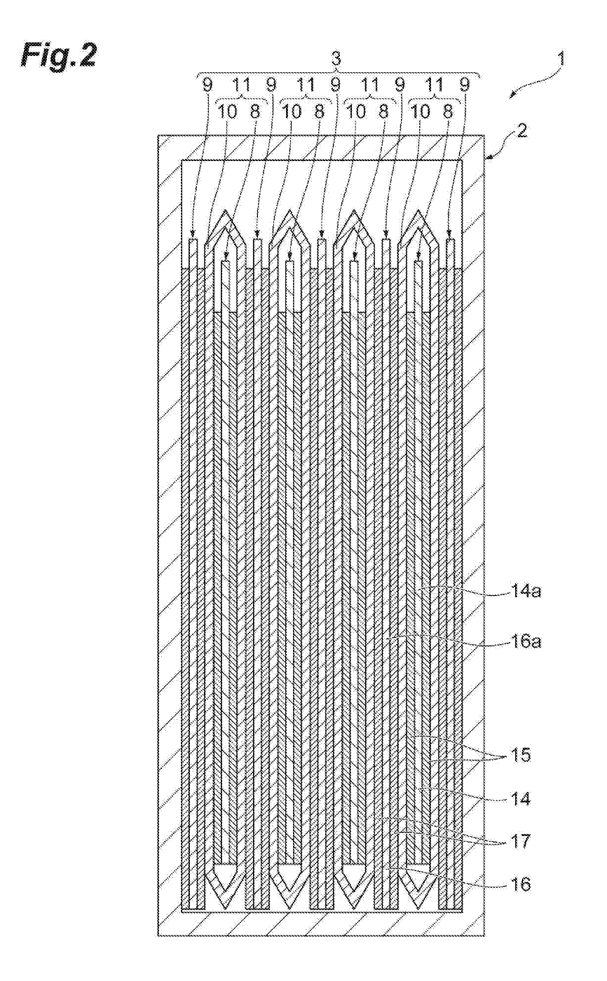

FIG. 1 is a cross-sectional view illustrating an interior of a power storage device manufactured by applying an electrode stacking device according to an embodiment of the invention. FIG. 2 is a cross-sectional view taken along II-II line of FIG. 1. In FIG. 1 and FIG. 2, a power storage device 1 is a lithium ion secondary battery having a stacked electrode assembly.

For example, the power storage device 1 includes a case 2 having a shape of a substantially rectangular parallelepiped and an electrode assembly 3 accommodated in the case 2. For example, the case 2 is made of a metal such as aluminum. Although not illustrated, for example, a nonaqueous (organic solvent) electrolytic solution is injected into the case 2. On the case 2, a positive electrode terminal 4 and a negative electrode terminal 5 are disposed to be spaced apart from each other. The positive electrode terminal 4 is fixed to the case 2 through an insulating ring 6 and the negative electrode terminal 5 is fixed to the case 2 through an insulating ring 7. In addition, although not illustrated, an insulating film is disposed between the electrode assembly 3 and an inner side surface and bottom surface of the case 2, and the case 2 and the electrode assembly 3 are insulated from each other by the insulating film. In FIG. 1, for the sake of convenience, a slight gap is provided between a lower end of the electrode assembly 3 and the bottom surface of the case 2. However, in practice, the lower end of the electrode assembly 3 is in contact with the inner bottom surface of the case 2 through the insulating film. A gap may be formed between the electrode assembly 3 and the case 2 by disposing a spacer between the electrode assembly 3 and the case 2.

The electrode assembly 3 has a structure in which a plurality of positive electrodes 8 and a plurality of negative electrodes 9 are alternately stacked through bag-shaped separators 10. Each of the positive electrodes 8 is wrapped in each of the bag-shaped separators 10. The positive electrode 8 in a state of being wrapped by the bag-shaped separator 10 is configured as a separator-attached positive electrode 11. Therefore, the electrode assembly 3 has a structure in which a plurality of separator-attached positive electrodes 11 and the plurality of negative electrodes 9 are alternately stacked. Electrodes located at both ends of the electrode assembly 3 correspond to negative electrodes 9.

For example, each of the positive electrodes 8 includes a metal foil 14 which is a positive electrode current collector made of an aluminum foil and a positive electrode active material layer 15 formed on both sides of the metal foil 14. The metal foil 14 includes a foil body portion 14a having a rectangular shape in planar view and a tab 14b integrated with the foil body portion 14a. The tab 14b protrudes from an edge near one longitudinal end of the foil body portion 14a. Further, the tab 14b penetrates through the separator 10. The tab 14b is connected to the positive electrode terminal 4 through a conductive member 12. In FIG. 2, the tab 14b is omitted for convenience.

The positive electrode active material layer 15 is formed on both front and rear sides of the foil body portion 14a. The positive electrode active material layer 15 is a porous layer formed to include a positive electrode active material and a binder. Examples of the positive electrode active material may include a complex oxide, metallic lithium, sulfur, etc. For example, the complex oxide contains at least one of manganese, nickel, cobalt, and aluminum and lithium.

For example, each of the negative electrodes 9 includes a metal foil 16 which is a negative electrode current collector made of a copper foil and a negative electrode active material layer 17 formed on both sides of the metal foil 16. The metal foil 16 includes a foil body portion 16a having a rectangular shape in planar view and a tab 16b integrated with the foil body portion 16a. The tab 16b protrudes from an edge near one longitudinal end of the foil body portion 16a. The tab 16b is connected to the negative electrode terminal 5 through a conductive member 13. In FIG. 2, the tab 16b is omitted for convenience.

The negative electrode active material layer 17 is formed on both front and rear sides of the foil body portion 16a. The negative electrode active material layer 17 is a porous layer formed to include a negative electrode active material and a binder. Examples of the negative electrode active material may include carbon such as graphite, highly oriented graphite, mesocarbon microbeads, hard carbon, or soft carbon, an alkali metal such as lithium or sodium, a metal compound, a metal oxide such as SiOx (0.5≤x≤1.5), boron-added carbon, etc.

The separator 10 has a rectangular shape in planar view. Examples of a material for forming the separator 10 include a porous film made of a polyolefin resin such as polyethylene (PE) or polypropylene (PP), or a woven fabric or a nonwoven fabric made of polypropylene, polyethylene terephthalate (PET), methyl cellulose, etc.

In the case of manufacturing the power storage device 1 configured as described above, first, after the separator-attached positive electrodes 11 and the negative electrodes 9 are manufactured, the separator-attached positive electrodes 11 and the negative electrodes 9 are alternatively stacked, and the separator-attached positive electrodes 11 and the negative electrodes 9 are fixed, thereby obtaining the electrode assembly 3. Then, after the tab 14b of the separator-attached positive electrode 11 is connected to the positive electrode terminal 4 through the conductive member 12 and the tab 16b of the negative electrode 9 is connected to the negative electrode terminal 5 through the conductive member 13, the electrode assembly 3 is accommodated in the case 2.

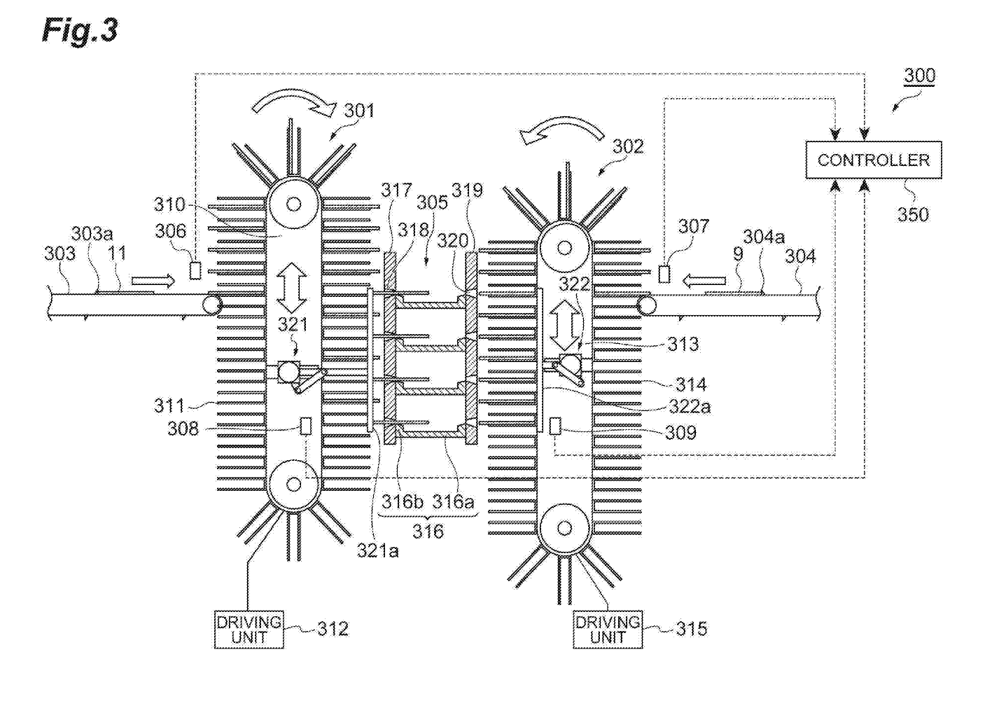

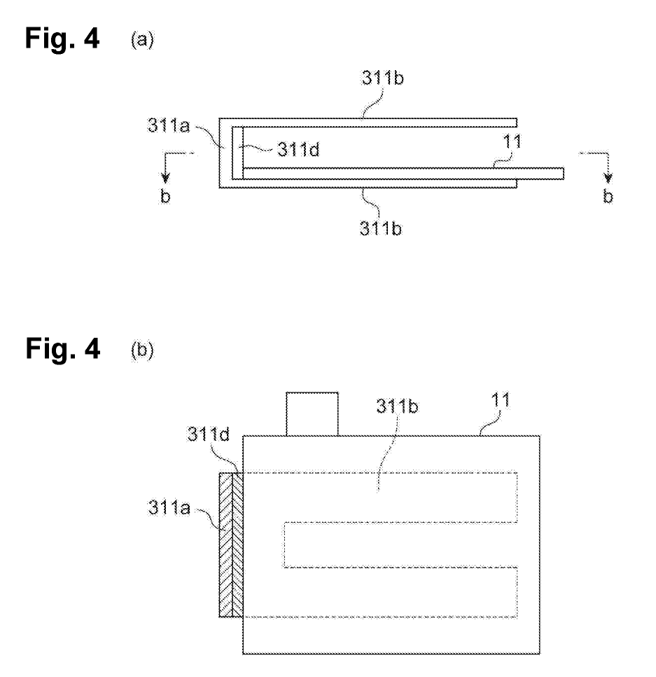

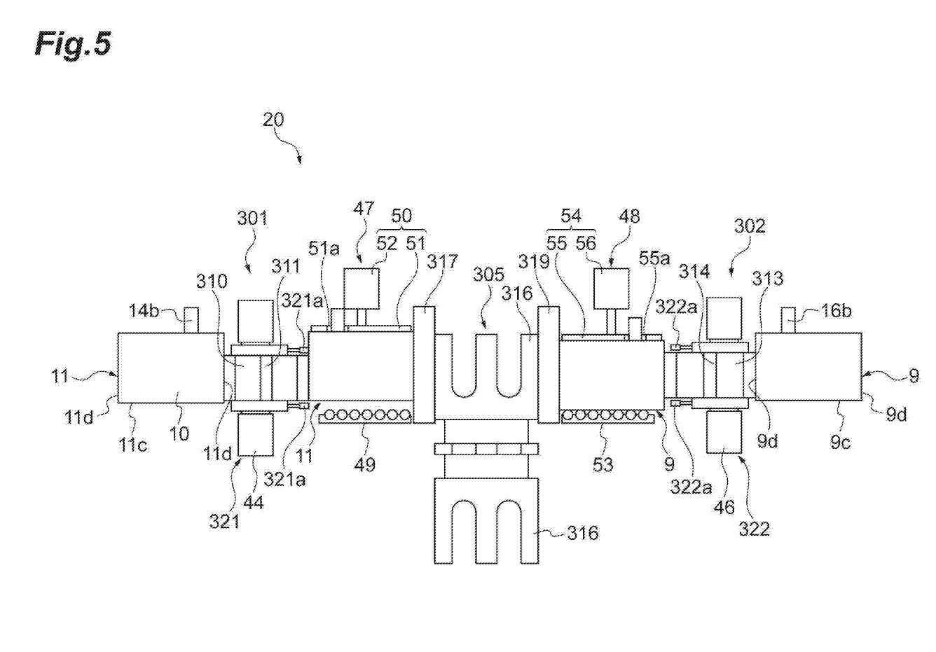

Next, a description will be given of an electrode stacking device 300 according to the embodiment of the invention with reference to FIG. 3 to FIG. 5. FIG. 3 is a side view (including partial cross section) illustrating the electrode stacking device 300. FIG. 4 is a diagram illustrating a configuration of a support of the electrode stacking device 300. FIG. 5 is a plan view of the electrode stacking device 300.

The electrode stacking device 300 includes a positive electrode conveying unit 301, a negative electrode conveying unit 302, a positive electrode supplying conveyor 303, a negative electrode supplying conveyor 304, and a stacked unit 305. In addition, the electrode stacking device 300 includes electrode supply sensors 306 and 307 and stacking position sensors 308 and 309.

The positive electrode conveying unit 301 is a unit that successively conveys the separator-attached positive electrodes 11 while storing the positive electrodes. The positive electrode conveying unit 301 includes a loop-shaped circulating member (mounting member) 310 extending in a vertical direction, a plurality of supports 311 attached to an outer peripheral surface of the circulating member 310 to support the separator-attached positive electrodes 11, and a driving unit 312 that drives the circulating member 310.

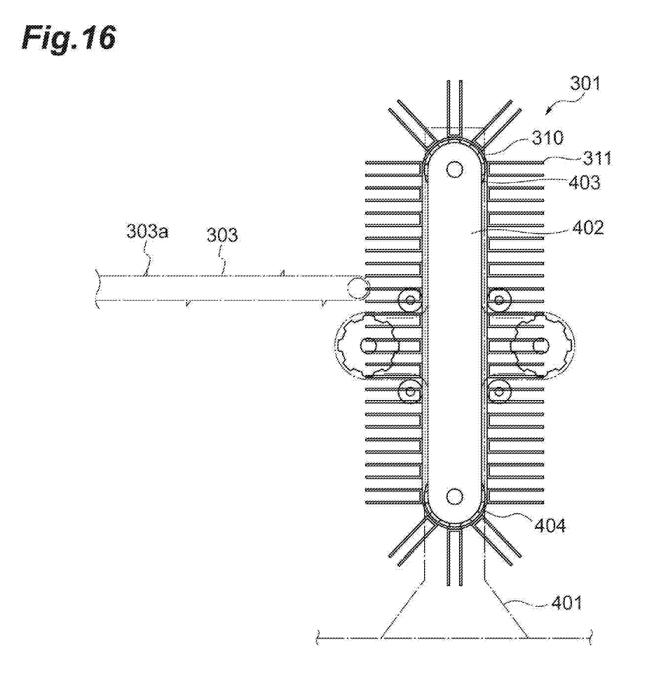

For example, the circulating member 310 includes an endless belt. The circulating member 310 is bridged over two rollers disposed to be spaced apart from each other in the vertical direction to rotate together with rotation of each of the rollers. When the circulating member 310 rotates (circulates) in this way, each of the supports 311 circulates and moves. In addition, the circulating member 310 is movable in the vertical direction together with the two rollers. To prevent a phase shift between the circulating member 310 and the rollers, the circulating member 310 may be used as a toothed belt, and the rollers may be used as sprockets. In the present embodiment, sprockets 403 and 404 (see FIG. 16) described below correspond to the two rollers.

The driving unit 312 rotates the circulating member 310 and moves the circulating member 310 in the vertical direction. The driving unit 312 includes two motors, and an example according to the present embodiment will be described below with reference to FIG. 16, etc. The driving unit 312 rotates the circulating member 310 in a clockwise direction when viewed from a front side of the electrode stacking device 300 (a front side of a paper surface of FIG. 3). Therefore, a support 311 on the positive electrode supplying conveyor 303 side rises with respect to the circulating member 310, and a support 311 on the stacked unit 305 side lowers with respect to the circulating member 310.

FIG. 4(a) is a side view of the support 311 in a state in which the separator-attached positive electrode 11 is supported, and FIG. 4(b) is a cross-sectional view taken along b-b line of FIG. 4(a). As illustrated in FIG. 4, the support 311 is a member having a U-shaped cross section including a bottom wall 311a and a pair of side walls 311b. The bottom wall 311a corresponds to a rectangular plate member attached to the outer peripheral surface of the circulating member 310. The pair of side walls 311b corresponds to rectangular plate members erected on both edges of the bottom wall 311a in a direction in which the circulating member 310 circulates. As illustrated in FIG. 4(b), as an example in the present embodiment, the side walls 311b are formed in a bifurcated shape. However, the side walls 311b may have any shape as long as the shape can support the separator-attached positive electrode 11. The pair of side walls 311b faces each other and is spaced apart to an extent at which the separator-attached positive electrode 11 can be accommodated. For example, the bottom wall 311a and the side walls 311b are integrally formed of a metal such as stainless steel.

A cushioning material 311d such as a sponge is provided on an inner surface of the bottom wall 311a. The separator-attached positive electrode 11 supplied from the positive electrode supplying conveyor 303 to the support 311 collides with the cushioning material 311d. However, an impact of collision is softened by the cushioning material 311d. That is, the cushioning material 311d functions as an impact softening portion that softens an impact on the separator-attached positive electrode 11 when the support 311 receives the separator-attached positive electrode 11. As a result, when the separator-attached positive electrode 11 is supplied to the support 311, separation of the positive electrode active material layer 15 of the separator-attached positive electrode 11 can be suppressed.

The negative electrode conveying unit 302 is a unit that successively conveys the negative electrodes 9 while storing the negative electrodes. The negative electrode conveying unit 302 includes a loop-shaped circulating member (mounting member) 313 extending in the vertical direction, a plurality of supports 314 attached to an outer peripheral surface of the circulating member 313 to support the negative electrodes 9, and a driving unit 315 that drives the circulating member 313. Here, in addition, a configuration of the supports 314 is the same as that of the supports 311.

Similarly to the circulating member 310, for example, the circulating member 313 includes an endless belt. The circulating member 313 is bridged over two rollers disposed to be spaced apart from each other in the vertical direction to rotate together with rotation of each of the rollers. When the circulating member 313 rotates (circulates) in this way, each of the supports 314 circulates and moves. In addition, the circulating member 313 is movable in the vertical direction together with the two rollers.

The driving unit 315 rotates the circulating member 313 and moves the circulating member 313 in the vertical direction. The driving unit 315 has the same configuration as that of the driving unit 312 and includes two motors, and an example according to the present embodiment will be described below with reference to FIG. 16, etc. The driving unit 315 rotates the circulating member 313 in a counterclockwise direction when viewed from the front side of the electrode stacking device 300 (the front side of the paper surface of FIG. 3). Therefore, a support 314 on the negative electrode supplying conveyor 304 side rises with respect to the circulating member 313, and a support 314 on the stacked unit 305 side lowers with respect to the circulating member 313.

The positive electrode supplying conveyor 303 horizontally conveys the separator-attached positive electrode 11 toward the positive electrode conveying unit 301 and supplies the separator-attached positive electrode 11 to the support 311 of the positive electrode conveying unit 301. The positive electrode supplying conveyor 303 has a plurality of claws 303a provided at equal intervals along a circulation direction of the positive electrode supplying conveyor 303. The claws 303a extend in a direction orthogonal to the circulation direction and abut against an end of the separator-attached positive electrode 11 on a rear side in a conveying direction. In this way, the separator-attached positive electrodes 11 are supplied to the positive electrode conveying unit 301 at regular intervals.

The negative electrode supplying conveyor 304 horizontally conveys the negative electrode 9 toward the negative electrode conveying unit 302 and supplies the negative electrode 9 to the support 314 of the negative electrode conveying unit 302. The negative electrode supplying conveyor 304 has a plurality of claws 304a provided at equal intervals along a circulation direction of the negative electrode supplying conveyor 304. The claws 304a extend in a direction orthogonal to the circulation direction and abut against an end of the negative electrode 9 on a rear side in the conveying direction. In this way, the negative electrodes 9 are supplied to the negative electrode conveying unit 302 at regular intervals.

The separator-attached positive electrode 11 transferred from the positive electrode supplying conveyor 303 to the support 311 of the positive electrode conveying unit 301 circulates and moves to rise first and then lower by rotation of the circulating member 310. In this instance, a front and a rear of the separator-attached positive electrode 11 is reversed at an upper portion of the circulating member 310. The negative electrode 9 transferred from the negative electrode supplying conveyor 304 to the support 314 of the negative electrode conveying unit 302 circulates and moves to rise first and then lower by rotation of the circulating member 313. In this instance, a front and a rear of the negative electrode 9 is reversed at an upper portion of the circulating member 313.

The stacked unit 305 is disposed between the positive electrode conveying unit 301 and the negative electrode conveying unit 302. As an example, the stacked unit 305 includes a loop-shaped circulating member (not illustrated) extending in the vertical direction, a plurality of stacked portions 316 which is attached to an outer peripheral surface of this circulating member and on which the separator-attached positive electrodes 11 and the negative electrodes 9 are alternately stacked, and a driving unit (not illustrated) that drives the circulating member.

Each of the stacked portions 316 includes a plate-shaped base 316a on which the separator-attached positive electrodes 11 and the negative electrodes 9 are placed and a side wall 316b having a U-shaped cross section erected on the base 316a to position a bottom edge 11c and a side edge 11d of the separator-attached positive electrode 11 (see FIG. 4) and a bottom edge 9c and a side edge 9d of the negative electrode 9 (see FIG. 5). In addition, here, as an example, as illustrated in FIG. 3, an upper surface of the side wall 316b on the positive electrode conveying unit 301 side corresponds to an inclined surface which is inclined downward toward the base 316a. Similarly, an upper surface of the side wall 316b on the negative electrode conveying unit 302 side corresponds to an inclined surface inclined downward toward the base 316a. According to this configuration, the separator-attached positive electrode 11 and the negative electrode 9 can smoothly move to the base 316a.

A wall 317 extending in the vertical direction is disposed between the stacked unit 305 and the positive electrode conveying unit 301. A plurality of (here, four) slits 318 through which the separator-attached positive electrodes 11 extruded by an extrusion unit 321 described below pass is provided in the wall 317. The respective slits 318 are disposed at equal intervals in the vertical direction. In the present embodiment, as an example, an upper portion of each of the slits 318 corresponds to an inclined surface inclined downward from the positive electrode conveying unit 301 side toward the stacked portion 316 side. In addition, a lower portion of the slit 318 corresponds to an inclined surface inclined upward from the positive electrode conveying unit 301 side toward the stacked portion 316 side. In this way, it is possible to properly guide the separator-attached positive electrode 11 to the stacked portion 316 and to enlarge an opening part of the slit 318 on an inlet side (the positive electrode conveying unit 301 side). As a result, even when a slight shift occurs at a height position of the separator-attached positive electrode 11 extruded by the extrusion unit 321, it is possible to allow the separator-attached positive electrode 11 to pass through the slit 318.

A wall 319 extending the vertical direction is disposed between the stacked unit 305 and the negative electrode conveying unit 302. A plurality of (here, four) slits 320 through which the negative electrodes 9 extruded by an extrusion unit 322 described below pass is provided in the wall 319. A height position of each of the slits 320 is the same as a height position of each of the slits 318. In the present embodiment, as an example, an upper portion of the slit 320 corresponds to an inclined surface inclined downward from the negative electrode conveying unit 302 side toward the stacked portion 316 side. In addition, a lower portion of the slit 320 corresponds to an inclined surface inclined upward from the negative electrode conveying unit 302 side toward the stacked portion 316 side. In this way, it is possible to properly guide the negative electrode 9 to the stacked portion 316 and to enlarge an opening part of the slit 320 on an inlet side (the negative electrode conveying unit 302 side). As a result, even when a slight shift occurs at a height position of the negative electrode 9 extruded by the extrusion unit 322, it is possible to allow the negative electrode 9 to pass through the slit 320.

In addition, the electrode stacking device 300 includes the extrusion unit 321 and the extrusion unit 322.

In a stacking area in which the separator-attached positive electrodes 11 are stacked, the extrusion unit 321 simultaneously extrudes a plurality of (here, four) separator-attached positive electrodes 11 toward stacked portions 316 of a plurality of upper and lower levels (here, four upper and lower levels), thereby simultaneously stacking the four separator-attached positive electrodes 11 on the stacked portions 316 of the four levels. The extrusion unit 321 includes a pair of pushing members 321a (discharge portions) that pushes the four separator-attached positive electrodes 11 together and a driving unit 44 (see FIG. 5) that moves the pushing members 321a to a side of the stacked portions 316 of the four levels. For example, the driving unit 44 includes a motor and a link mechanism.

In a stacking area in which the negative electrodes 9 are stacked, the extrusion unit 322 simultaneously extrudes a plurality of (here, four) negative electrodes 9 toward the stacked portions 316 having a plurality of upper and lower levels (here, four upper and lower levels), thereby simultaneously stacking the four negative electrodes 9 on the stacked portions 316 of the four levels. The extrusion unit 322 includes a pair of pushing members 322a (discharge portions) that pushes the four negative electrodes 9 together and a driving unit 46 (see FIG. 5) that moves the pushing members 322a to a side of the stacked portions 316 of the four levels. This configuration of the driving unit 46 is the same as that of the driving unit of the extrusion unit 321. A cylinder, etc. may be provided as the driving unit of each of the extrusion units 321 and 322.

In addition, as illustrated in FIG. 5, the electrode stacking device 300 includes a positioning unit 47 that aligns a position of the bottom edge 11c of the separator-attached positive electrode 11 and a positioning unit 48 that aligns a position of the bottom edge 9c of the negative electrode 9. The positioning units 47 and 48 are disposed in the stacking areas in which the separator-attached positive electrode 11 and the negative electrode 9 are stacked. The bottom edge 11c of the separator-attached positive electrode 11 corresponds to an edge of the separator-attached positive electrode 11 on an opposite side from the tab 14b side. The bottom edge 9c of the negative electrode 9 corresponds to an edge of the negative electrode 9 on an opposite side from the tab 16b side.

The positioning unit 47 includes a receiving portion 49 disposed on a front side of the positive electrode conveying unit 301 (on the front side of the paper surface of FIG. 3) to abut against the bottom edge 11c of the separator-attached positive electrode 11 and a pressing portion 50 disposed on a rear side of the positive electrode conveying unit 301 to press the separator-attached positive electrode 11 against the receiving portion 49. In the receiving portion 49, a plurality of free rollers is provided side by side. The receiving portion 49 made be formed of a resin whose surface is slippery. Positioning units 47, the number of which is the same as the number of slits 318, are provided and disposed at heights corresponding to the slits 318.

The pressing portion 50 includes a pushing plate 51 that pushes the separator-attached positive electrode 11 and a driving unit 52 that moves the pushing plate 51 to the receiving portion 49 side. For example, the driving unit 52 has a cylinder. The pushing plate 51 is fixed to a distal end of a piston rod of the cylinder. A slit 51a for allowing the tab 14b of the separator-attached positive electrode 11 to escape is provided in the pushing plate 51.

The positioning unit 48 includes a receiving portion 53 disposed on a front side of the negative electrode conveying unit 302 (on the front side of the paper surface of FIG. 3) to abut against the bottom edge 9c of the negative electrode 9 and a pressing portion 54 disposed on a rear side of the negative electrode conveying unit 302 to press the negative electrode 9 against the receiving portion 53. A structure of the receiving portion 53 is the same as that of the receiving portion 49. Positioning units 48, the number of which is the same as the number of slits 320, are provided and disposed at heights corresponding to the slits 320. The pressing portion 54 includes a pushing plate 55 that pushes the negative electrode 9 and a driving unit 56 that moves the pushing plate 55 to the receiving portion 53 side. A slit 55a for allowing the tab 16b of the negative electrode 9 to escape is provided in the pushing plate 55. A configuration of the driving unit 56 is the same as that of the driving unit 52.

In addition, as illustrated in FIG. 3, the electrode stacking device 300 includes a controller 350. The controller 350 includes a central processing unit (CPU), a random access memory (RAM), a read only memory (ROM), an input/output interface, etc. The controller 350 includes a conveyance control unit that controls the driving units 312 and 315, a stacking control unit that controls the driving unit of the stacked unit 305, an extrusion control unit that controls the driving unit of the extrusion unit 321 and the driving unit of the extrusion unit 322, and a positioning control unit that controls driving units of the positioning units 47 and 48. In addition, the controller 350 is connected to the electrode supply sensors 306 and 307 and the stacking position sensors 308 and 309, and can receive detection signals from these sensors. The controller 350 determines control contents on the basis of the detection signals from the respective sensors and a program saved in the ROM, and drives and controls each driving unit through each control unit.

The electrode supply sensor 306 is disposed around an end of the positive electrode supplying conveyor 303 on the positive electrode conveying unit 301 side to detect presence or absence of the claw 303a or the separator-attached positive electrode 11. The electrode supply sensor 306 periodically transmits a detection signal indicating the presence or absence of the claw 303a or the separator-attached positive electrode 11 to the controller 350.

The electrode supply sensor 307 is disposed around an end of the negative electrode supplying conveyor 304 on the negative electrode conveying unit 302 side to detect presence or absence of the claw 304a or the negative electrode 9. The electrode supply sensor 307 periodically transmits a detection signal indicating the presence or absence of the claw 304a or the negative electrode 9 to the controller 350.

The stacking position sensor 308 detects that the support 311 supporting the separator-attached positive electrode 11 has reached a predetermined stacking position (for example, a lower end position of the slit 318 corresponding to a lowermost stacked portion 316 of the stacked unit 305). The stacking position sensor 308 is independent of vertical movement of the circulating member 310, and a height position of the stacking position sensor 308 is fixed with respect to the slit 318. Upon detecting that the support 311 supporting the separator-attached positive electrode 11 has reached the stacking position, the stacking position sensor 308 transmits a detection signal indicating this information to the controller 350.

The stacking position sensor 309 detects that the support 314 supporting the negative electrode 9 has reached a predetermined stacking position (for example, a lower end position of the slit 320 corresponding to a lowermost stacked portion 316 of the stacked unit 305). The stacking position sensor 309 is independent of vertical movement of the circulating member 313, and a height position of the stacking position sensor 309 is fixed with respect to the slit 320. Upon detecting that the support 314 supporting the negative electrode 9 has reached the stacking position, the stacking position sensor 309 transmits a detection signal indicating this information to the controller 350.

A characteristic configuration of the electrode stacking device 300 according to the present embodiment will be described. In description below, “n” is an integer of 2 or more, “m” is an integer of 2 or more, and “n” and “m” may be different integers or may be the same integer.

In the positive electrode conveying unit 301, the pushing members 321a of the extrusion unit 321 extrude a total of m separator-attached positive electrodes 11 at one interval with respect to supports 311 per n levels. That is, the pushing members 321a extrude a separator-attached positive electrode 11 of one support 311, skip supports 311 corresponding to (n−1) levels from the one support 311, and extrude a separator-attached positive electrode 11 of another support 311 present n levels above (or below) the one support 311. A part corresponding to an extrusion part in the pair of pushing members 321a extending in the vertical direction is set to have a width allowing contact with the separator-attached positive electrode 11. A part corresponding to a non-extrusion part in the pair of pushing members 321a is set to have a width to not contact the separator-attached positive electrode 11 to the outside in a width direction. In this way, when the pushing members 321a move to the stacked unit 305 side, only the separator-attached positive electrode 11 at a position corresponding to the extrusion part is extruded, and a state in which the separator-attached positive electrode 11 at a position corresponding to the non-extrusion part is supported by the support 311 is maintained.

In the negative electrode conveying unit 302, the pushing members 322a of the extrusion unit 322 extrude a total of m negative electrodes 9 at one interval with respect to supports 314 per n levels. That is, the pushing members 322a extrude a negative electrode 9 of one support 314, skip supports 314 corresponding to) levels from the one support 314, and extrude a negative electrode 9 of another support 314 present n levels above (or below) the one support 314. A part corresponding to an extrusion part in the pair of pushing members 322a extending in the vertical direction is set to have a width allowing contact with the negative electrode 9. A part corresponding to a non-extrusion part in the pair of pushing members 322a is set to have a width to avoid the negative electrode 9 to the outside in a width direction. In this way, when the pushing members 322a move to the stacked unit 305 side, only the negative electrode 9 at a position corresponding to the extrusion part is extruded, and a state in which the separator-attached positive electrode 11 at a position corresponding to the non-extrusion part is supported by the support 311 is maintained.

The stacked unit 305 has a total of m stacked portions 316 at one interval with respect to the supports 311 per n levels. The stacked unit 305 has a total of m stacked portions 316 at one interval with respect to the supports 314 per n levels. That is, the stacked unit 305 has a stacked portion 316 that receives a separator-attached positive electrode 11 from one support 311, skips supports 311 corresponding to (n−1) levels from the one support 311, and has a stacked portion 316 that receives a separator-attached positive electrode 11 from another support 311 present n levels above (or below) the one support 311. The stacked unit 305 has a stacked portion 316 that receives a negative electrode 9 from one support 314, skips supports 314 corresponding to (n−1) levels from the one support 314, and has a stacked portion 316 that receives a negative electrode 9 from another support 314 present n levels above (or below) the one support 314.

In an example illustrated in FIG. 3, “n=2” and “m=4” are set. Therefore, the pushing members 321a and 322a extrude a total of four electrodes at one interval with respect to the supports 311 and 314 per two levels. However, values to which the integers of n and m are set are not particularly limited. When n and m increase, intervals and the number of stacked portions 316 increase, and thus a total length of the stacked unit 305 in the vertical direction increases. Therefore, n and m may be set in consideration of constraints on a size of the entire device, etc.

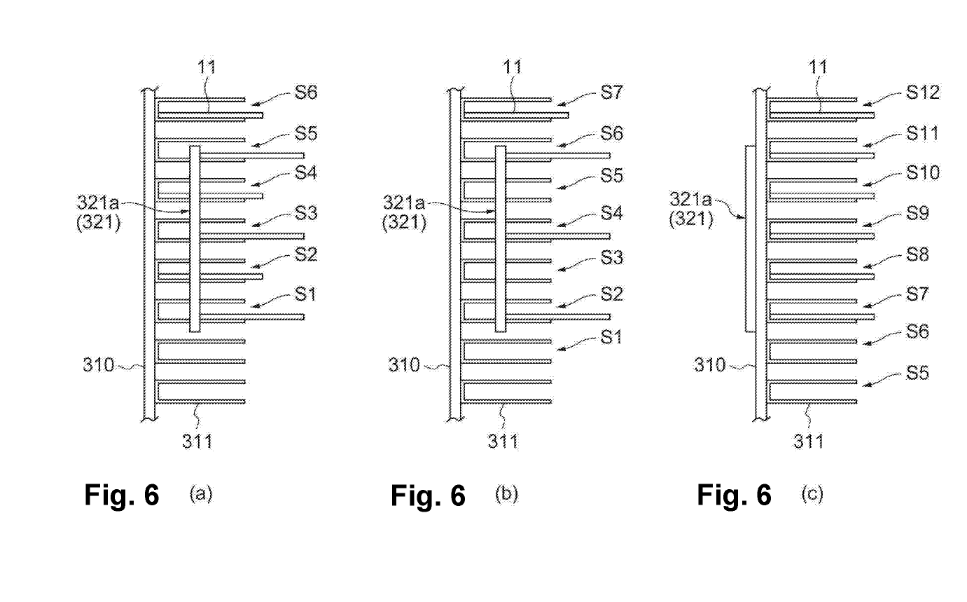

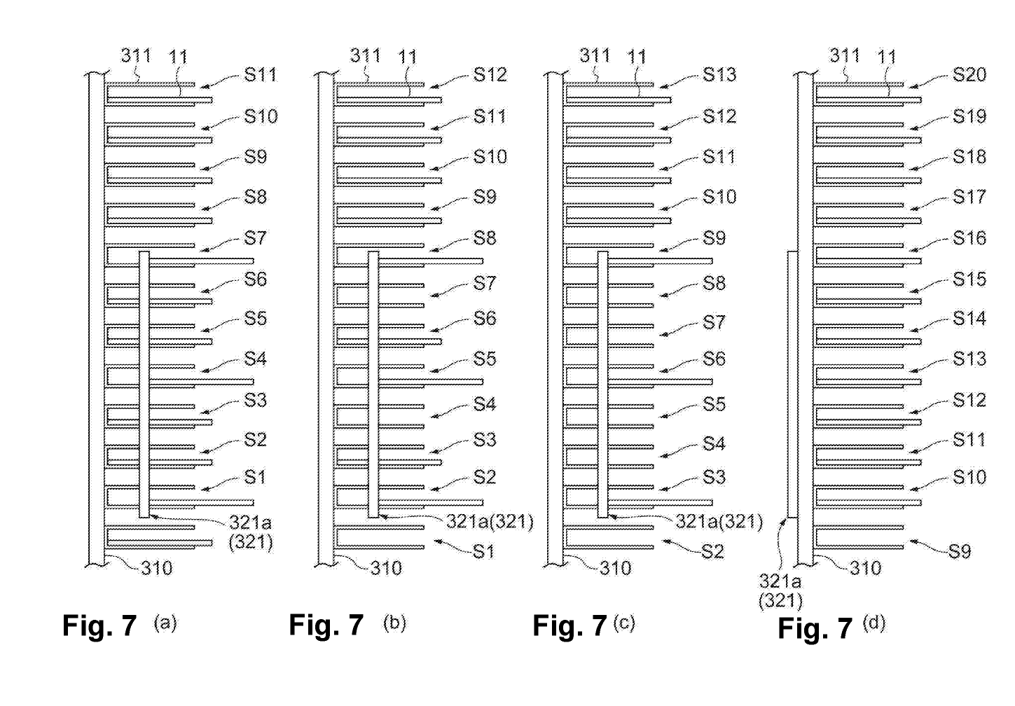

Next, a description will be given of an example of an operation of the electrode stacking device 300 with reference to FIG. 6 and FIG. 7. Here, a description will be given of only operations of the circulating member 310 and the pushing members 321a of the extrusion unit 321. Operations of the circulating member 313 and the pushing members 322a of the extrusion unit 322 have the same purposes as those of the circulating member 310 and the pushing members 321a of the extrusion unit 321 except that stacking timing is different such that the separator-attached positive electrodes 11 and the negative electrodes 9 are alternately stacked. In addition, a control flow of the operation of the entire electrode stacking device 300 will be described below.

The controller 350 executes a first extrusion operation of extruding In separator-attached positive electrodes 11 among the separator-attached positive electrodes 11 supported by the supports 311 using the pushing members 321a. Subsequently, the controller 350 executes a first movement operation of moving the circulating member 310 with respect to the pushing members 321a in the circulation direction by one level of the supports 311. Subsequently, after the first movement operation, the controller 350 executes a second extrusion operation of extruding the m separator-attached positive electrodes 11 using the pushing members 321a. Then, after executing the first movement operation and the second extrusion operation (n−1) times, the controller 350 executes a second movement operation of moving the circulating member 310 with respect to extrusion parts of the pushing members 321a in the circulation direction by {m×n (n−1)} levels of the supports 311. Thereafter, the respective operations from the first extrusion operation are repeated. The first movement operation and the second movement operation are set based on a difference in movement amount. However, in the driving unit 312 and the driving unit 315 of the present embodiment described below, control contents by the controller 350 for both movement operations are equivalent to each other.

The case of “n=2” will be described with reference to FIG. 6. Here, it is presumed that “m=3”. As illustrated in FIG. 6(a), the controller 350 executes the first extrusion operation of extruding three separator-attached positive electrodes 11 among the separator-attached positive electrodes 11 supported by the supports 311 using the pushing members 321a. Here, the pushing members 321a extrude separator-attached positive electrodes 11 of supports 311 related to S1, S3, and S5 by skipping one level. In this instance, separator-attached positive electrodes 11 related to S2, S4, and S6 are not extruded and remain in supports 311. After extrusion of the separator-attached positive electrodes 11 is completed, extrusion of negative electrodes 9 is performed. In subsequent operations, extrusion of the separator-attached positive electrodes 11 and extrusion of the negative electrodes 9 are alternately performed in a similar manner, and thus a description will be omitted.

Subsequently, as illustrated in FIG. 6(b), the controller 350 executes the first movement operation of moving the circulating member 310 with respect to extrusion parts of the pushing members 321a in the circulation direction by one level of the supports 311. In this way, supports 311 related to S2, S4, and S6 are disposed at positions corresponding to extrusion parts of the pushing members 321a. Subsequently, after the first movement operation, the controller 350 executes the second extrusion operation of extruding three separator-attached positive electrodes 11 using the pushing members 31a. In this way, separator-attached positive electrodes 11 of the supports 311 related to S2, S4, and S6 are extruded by the pushing members 321a. As described above, a total of six separator-attached positive electrodes 11 supported by the supports 311 related to S1 to S6 are all extruded.

Here, in FIG. 6, since “n=2”, that is, “n−1=1”, the first movement operation and the second extrusion operation are executed only once. In addition, since “m=3”, “m×n−(n−1)=5” is obtained. Therefore, as illustrated in FIG. 6(c), the controller 350 executes the second movement operation of moving the circulating member 310 with respect to extrusion parts of the pushing members 321a in the circulation direction by five levels of the supports 311. In this way, supports 311 related to S7, S9, and S11 are disposed at positions corresponding to extrusion parts of the pushing members 321a. That is, operations similar to those of the supports 311 related to S1 to S6 are performed on supports 311 related to S7 to S12.

Further, the case of “n=3” will be described with reference to FIG. 7. Here, it is presumed that “m=3”. As illustrated in FIG. 7(a), the controller 350 executes the first extrusion operation of extruding three separator-attached positive electrodes 11 among the separator-attached positive electrodes 11 supported by the supports 311 using the pushing members 321a. Here, the pushing members 321a extrude separator-attached positive electrodes 11 of supports 311 related to S1, S4, and S7 by skipping two levels. In this instance, separator-attached positive electrodes 11 related to S2, S3, S5, S6, S8 and S9 are not extruded and remain in supports 311.

Subsequently, as illustrated in FIG. 7(b), the controller 350 executes the first movement operation of moving the circulating member 310 with respect to extrusion parts of the pushing members 321a in the circulation direction by one level of the supports 311. In this way, supports 311 related to S2, S5, and S8 are disposed at positions corresponding to extrusion parts of the pushing members 321a. Subsequently, after the first movement operation, the controller 350 executes the second extrusion operation of extruding three separator-attached positive electrodes 11 using the pushing members 321a. In this way, separator-attached positive electrodes 11 of the supports 311 related to S2, S5, and S8 are extruded by the pushing members 321a. In this instance, separator-attached positive electrodes 11 related to S3, S6, and S9 are not extruded and remain in supports 311.

Here, in FIG. 7, since “n=3”, that is, “n−1=2”, the first movement operation and the second extrusion operation are executed twice. Therefore, after the second extrusion operation of the first time, the first movement operation of the second time is executed, and then the second extrusion operation of the second time is executed.

Specifically, as illustrated in FIG. 7(c), the controller 350 executes the first movement operation (second time) of moving the circulating member 310 with respect to extrusion parts of the pushing members 321a in the circulation direction by one level of the supports 311. In this way, supports 311 related to S3, S6, and S9 are disposed at positions corresponding to extrusion parts of the pushing members 321a. Subsequently, after the first movement operation of the second time, the controller 350 executes the second extrusion operation (second time) of extruding three separator-attached positive electrodes 11 using the pushing members 321a. In this way, separator-attached positive electrodes 11 of the supports 311 related to S3, S6, and S9 are extruded by the pushing members 321a. As described above, a total of nine separator-attached positive electrodes 11 supported by the supports 311 related to S1 to S9 are all extruded.

In FIG. 7, since “n=3” and “m 32 3”, “m×n (n−1)=7” is obtained. Therefore, after a total of two times of the first movement operation and the second extrusion operation are performed, as illustrated in FIG. 7(d), the controller 350 executes the second movement operation of moving the circulating member 310 with respect to extrusion parts of the pushing members 321a in the circulation direction by seven levels of the supports 311. In this way, supports 311 related to S10, S13, and S16 are disposed at positions corresponding to extrusion parts of the pushing members 321a. That is, operations similar to those of the supports 311 related to S1 to S9 are performed on supports 311 related to S10 to S18.

The integers of “n” and “m” are merely examples. When the integers are changed, an operation having the same purpose as that of the operation described above is performed accordingly.

Next, a description will be given of the driving unit 312, the driving unit 315, and related configurations in the present embodiment with reference to FIG. 16 to FIG. 21. Here, a description will be given of a support structure and a drive mechanism on the positive electrode conveying unit 301 side. A similar support structure and drive mechanism can be adopted for the negative electrode conveying unit 102.

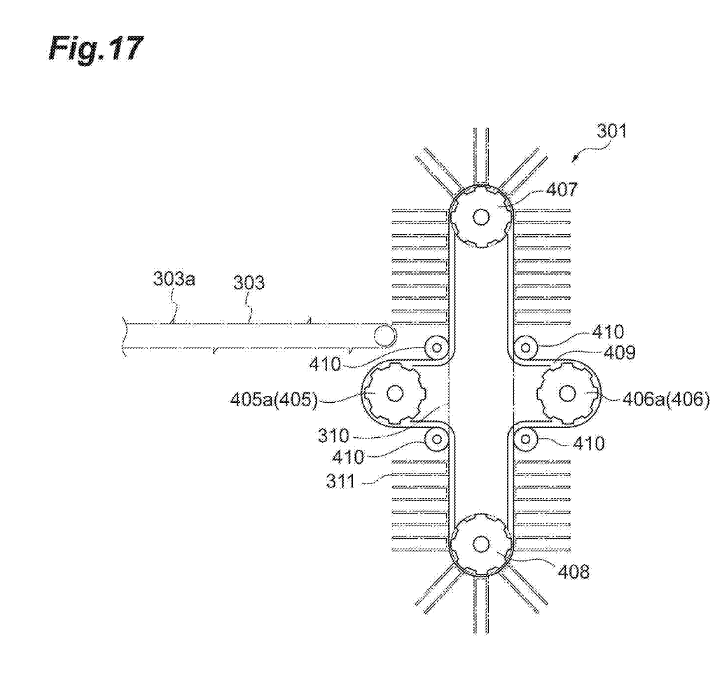

FIG. 16 and FIG. 17 are diagrams focusing on a configuration required for description of the support structure and the drive mechanism of the positive electrode conveying unit 301, and illustration of other configurations is omitted as appropriate. As illustrated in FIG. 16, the positive electrode conveying unit 301 includes a support frame 401 installed on a floor surface and a circulation frame 402 supported to be movable in the vertical direction with respect to the support frame 401. A pair of sprockets 403 and 404 disposed to be spaced apart from each other by a predetermined interval in the vertical direction is rotatably supported. The circulating member 310 having the plurality of supports 311 disposed on the outer peripheral surface is wound around the sprockets 403 and 404.

In addition, as illustrated in FIG. 17, the positive electrode conveying unit 301 includes the support frame 401 or motors 405 and 406 fixed to the floor surface. Drive gears 405a and 406a are fixed to drive shafts of the motors 405 and 406. The sprockets 403 and 404 have drive gears 407 and 408 at one ends of rotating shafts thereof. A timing belt 409 is wound around the drive gears 405a, 406a, 407, and 408. A circulation path of the timing belt 409 forms a substantially cross shape that extends vertically and horizontally by a guide roller 410 (four guide rollers 410 in an example of FIG. 17) supported on the support frame 401 in addition to the drive gears 405a, 406a, 407, and 408.

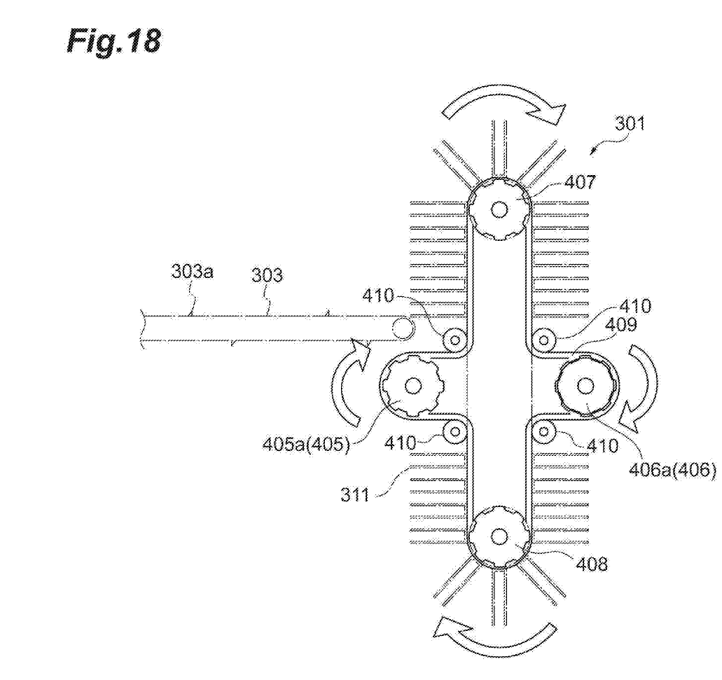

As illustrated in FIG. 18, when the drive gears 405a and 406a are rotated at the same speed, the circulating member 310 and the timing belt 409 perform only a circulation operation without the circulation frame 402 and the entire circulating member 310 vertically moving with respect to the support frame 401 or the floor surface.

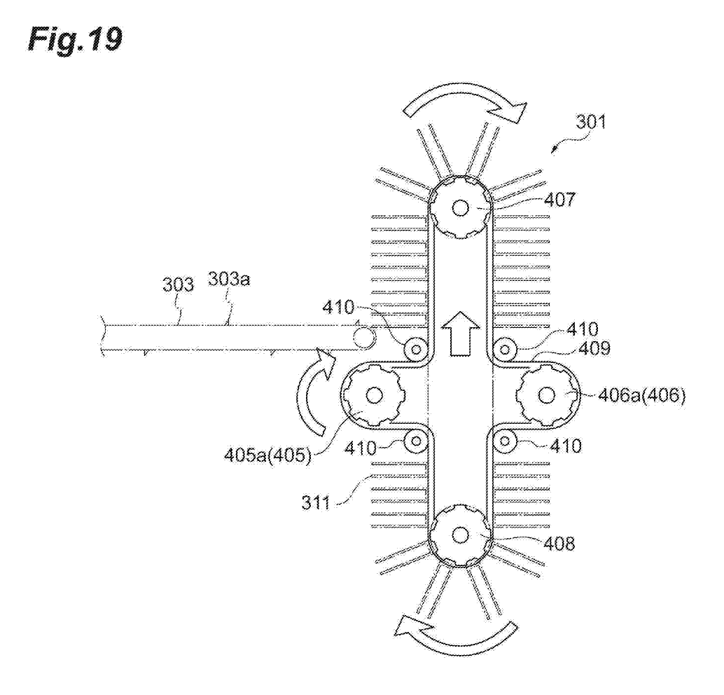

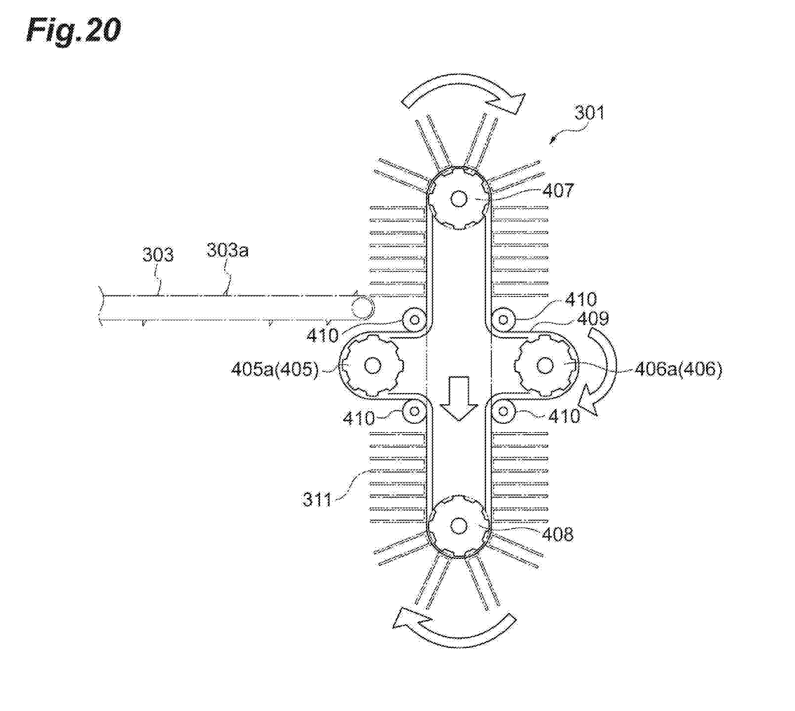

Meanwhile, as illustrated in FIG. 19, when only the drive gear 405a is rotated, the timing belt 409 circulates clockwise on the positive electrode supplying conveyor 303 side and stops on the stacked unit 305 side. For this reason, in response to such an operation of the timing belt 409, the circulation frame 402 rises with respect to the support frame 401 or the floor surface. Accordingly, a reference height position of the circulating member 310 (for example, a center position of the circulating member 310 in the vertical direction) supported on the circulation frame 402 through the sprockets 403 and 404 rises. In this instance, similarly to the timing belt 409, the circulating member 310 and the support 311 rise only on the positive electrode supplying conveyor 303 side. In addition, as illustrated in FIG. 20, when only the drive gear 406a is rotated, the timing belt 409 circulates clockwise on the stacked unit 305 side and stops on the positive electrode supplying conveyor 303 side. For this reason, in response to such an operation of the timing belt 409, the circulation frame 402 lowers with respect to the support frame 401 or the floor surface. Accordingly the reference height position of the circulating member 310 (for example, the center position of the circulating member 310 in the vertical direction) supported on the circulation frame 402 through the sprockets 403 and 404 lowers. In this instance, similarly to the timing belt 409, the circulating member 310 and the support 311 lower only on the stacked portion 316 side. Further, when both the drive gears 405a and 406a are rotated by making a rotating speed of the drive gear 405a different from a rotating speed of the drive gear 406a, the circulation frame 402 can be raised or lowered and the reference height position of the circulating member 310 may be raised or lowered depending on the difference in rotating speed.

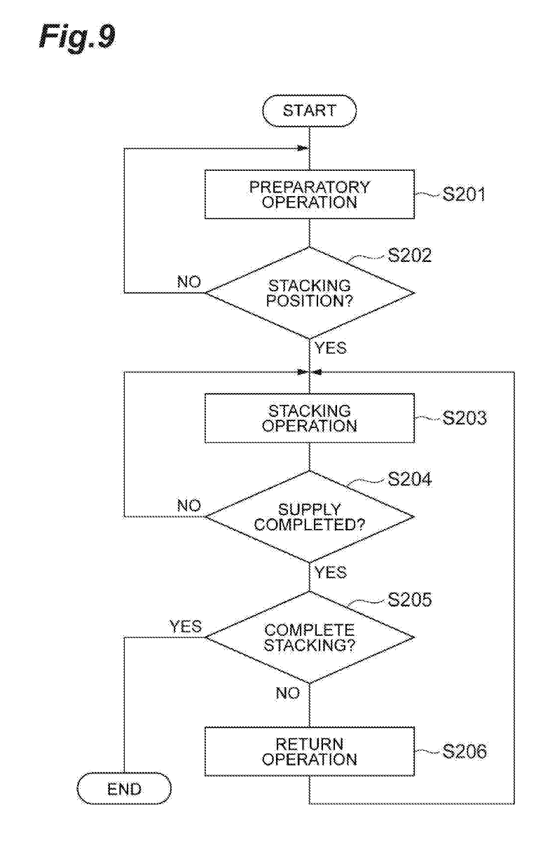

Next, a description will be given of operation control of the circulating members 310 and 313, the positioning units 47 and 48 (see FIG. 5), and the extrusion units 321 and 322 by the controller 350 with reference to FIG. 9 to FIG. 15.

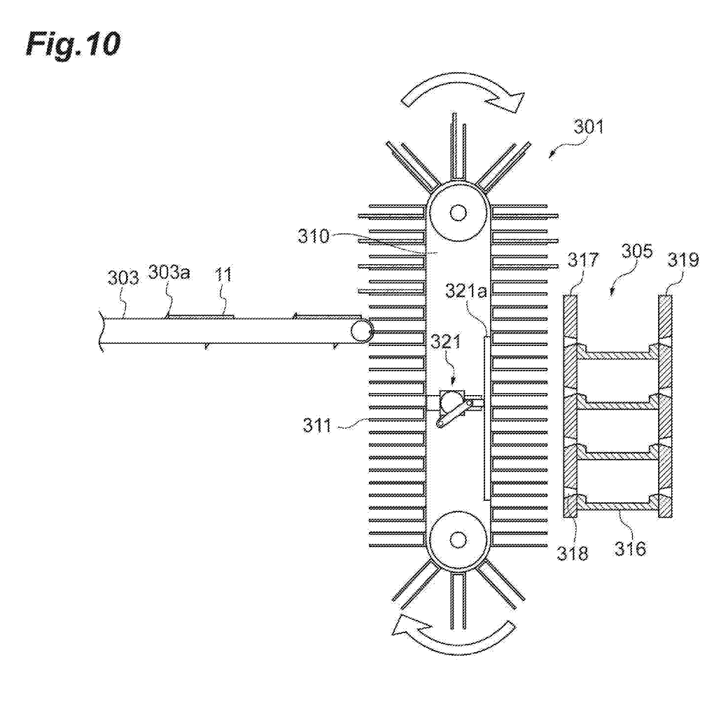

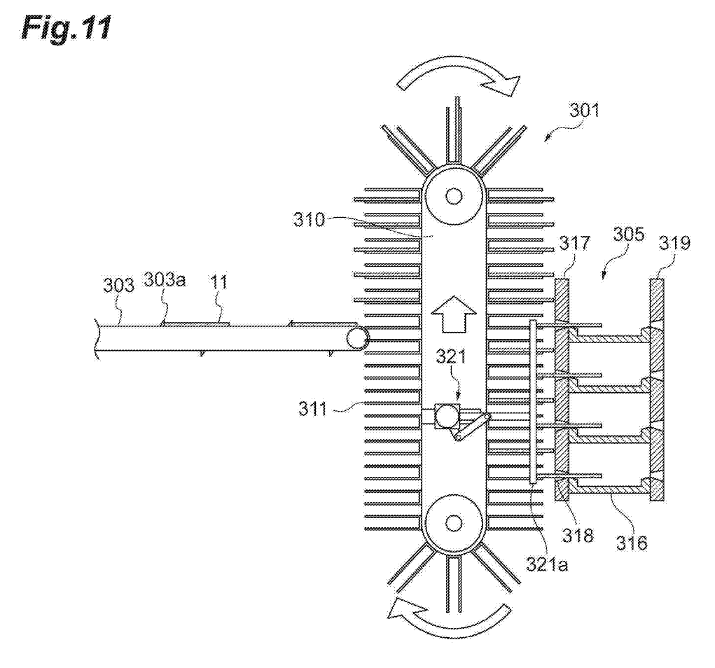

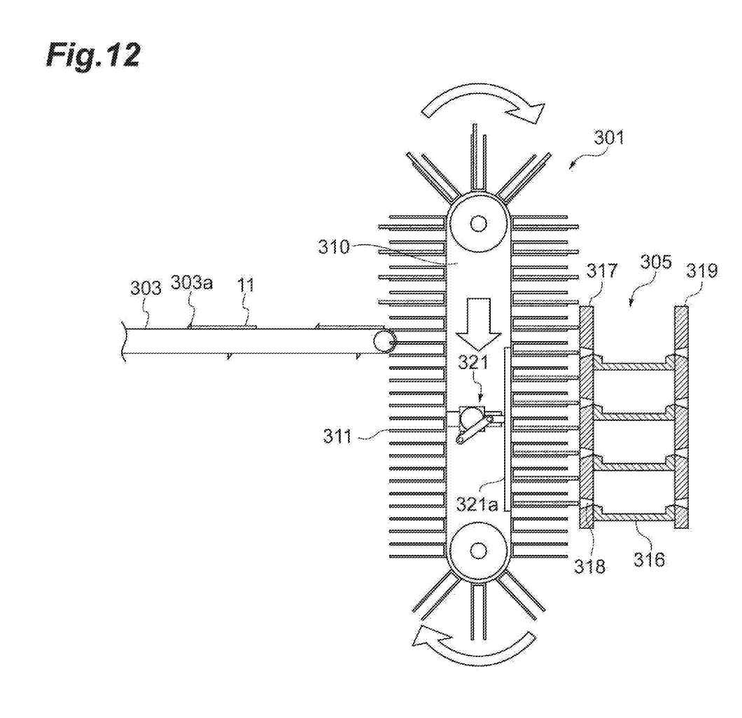

First, a description will be given of a control flow of a circulating member (here, as an example, the circulating member 310) with reference to FIG. 9 to FIG. 12. FIG. 9 is a flowchart illustrating a control flow common to the circulating member 310 and the circulating member 313. FIG. 10 is a partial side view for description of an operation of the circulating member 310 during a preparatory operation (step S201 of FIG. 9). FIG. 11 is a partial side view for description of an operation of the circulating member 310 during a stacking operation (step S203 of FIG. 9). FIG. 12 is a partial side view for description of an operation of the circulating member 310 during a return operation (step S206 of FIG. 9). The control flow of the circulating member 313 of the negative electrode conveying unit 302 is similar to the control flow of the circulating member 310, and thus a description thereof will be omitted.

In FIG. 9, the controller 350 receives a trigger (for example, input by an operator, etc.) of start of running of a manufacturing line including the electrode stacking device 300, and starts the preparatory operation of the circulating member 310 (step S201).

The preparatory operation is an operation for obtaining a state in which each support 311 present between a receiving position and a stacking position of the separator-attached positive electrode 11 supports the separator-attached positive electrode 11 from an initial state in which the separator-attached positive electrode 11 is not supported by any of the supports 311. Specifically, the preparatory operation is an operation of circulating the support 311 only by rotation (circulation) of the circulating member 310 (see FIG. 10). More specifically, this operation corresponds to a state of FIG. 18 and synchronously rotates the drive gears 405a and 406a. In a case in which a movement amount of a distance between supports 311 adjacent to each other in the circulating member 310 is set to 1, the controller 350 circulates the circulating member 310 clockwise when viewed from the front side of the paper surface of FIG. 3 (hereinafter merely referred to as “clockwise”) by a movement amount 1 each time supply of the separator-attached positive electrode 11 to the support 311 at the receiving position of the separator-attached positive electrode 11 in the circulating member 310 is confirmed. In description below, the movement amount is expressed by setting clockwise movement to a positive direction for circulation of the circulating member 310 and setting an upward direction to a positive direction for vertical movement of the circulating member 310.

During the preparatory operation, the controller 350 determines presence or absence of reception of a detection signal from the stacking position sensor 308 (that is, whether the support 311 supporting the separator-attached positive electrode 11 has reached the stacking position) as required (step S202). The controller 350 continues the preparatory operation of the circulating member 310 until the detection signal is received from the stacking position sensor 308 (step S202: NO). Meanwhile, upon receiving the detection signal from the stacking position sensor 308 (that is, upon detecting that the support 311 supporting the separator-attached positive electrode 11 has reached the stacking position), the controller 350 switches the circulating member 310 to the stacking operation (step S202: YES, step S203).

The stacking operation is an operation for stacking the separator-attached positive electrode 11 on the stacked portion 316. Specifically, the stacking operation is an operation of stopping a height position of the support 311 on the stacked unit 305 side relative to the stacked portion 316 and raising the support 311 on the positive electrode supplying conveyor 303 side by the movement amount 1 with respect to the positive electrode supplying conveyor 303 each time one separator-attached positive electrode 11 is supplied from the positive electrode supplying conveyor 303. More specifically, this operation corresponds to an operation state of FIG. 19 and stops the drive gear 406a and rotates only the drive gear 405a during the stacking operation. During a time (hereinafter referred to as a “unit time”) from when one separator-attached positive electrode 11 is supplied from the positive electrode supplying conveyor 303 until a subsequent separator-attached positive electrode 11 is supplied, the drive gear 406a rotates by an amount corresponding to the movement amount 1. In this way, the support 311 rises by the movement amount 1 on the positive electrode supplying conveyor 303 side, and the entire circulating member 310 is circulated clockwise by a movement amount 0.5 and rises by the movement amount 0.5 (see FIG. 11).

During the stacking operation, the controller 350 determines whether simultaneous supply of four separator-attached positive electrodes 11 to stacked portions 316 of four levels has been completed as required (step S204). Specifically, it is determined whether an extrusion operation by the extrusion unit 321 described below has been completed. For example, it is possible to detect that the extrusion operation has been completed by detecting that the pushing members 321a have returned to original positions (positions before the separator-attached positive electrode 11 is extruded). The controller 350 continues the stacking operation of the circulating member 310 until detecting that the extrusion operation by the extrusion unit 321 has been completed (step S204: NO). On the other hand, upon detecting that the extrusion operation by the extrusion unit 321 has been completed (step S204: YES), the controller 350 determines whether to complete stacking of the separator-attached positive electrode 11 on the stacked unit 305 (step S205).

Specifically, for example, the controller 350 can detect the number of electrodes stacked on each stacked portion 316 using a sensor, etc., and determine whether to complete stacking by determining whether the number of stacked electrodes has reached a predetermined number. That is, the controller 350 can determine to complete stacking when the number of stacked electrodes has reached the predetermined number, and not to complete stacking when the number of stacked electrodes has not reached the predetermined number.

When it is determined to complete stacking (step S205: YES), the controller 350 ends control of the circulating member 310. On the other hand, when it is not determined to complete stacking (step S205: NO), the controller 350 switches the circulating member 310 to the return operation (step S206). When it is determined to complete stacking (step S205: YES), the controller 350 may end control of the circulating member 310 first, and then restart control of the circulating member 310 after replacement of the stacked portion 316 is completed and an instruction to start control is received from an operator, etc. In this case, the return operation (step S206) is started.

Next, an operation of the return operation will be described. In the stacking operation, the circulating member 310 merely moves to a position higher than an original position (a position before the stacking operation starts). However, the return operation includes an operation of returning (lowering) the circulating member 310 to the original position. Specifically, the return operation is an operation of sliding a height position of the support 311 at a head supporting the separator-attached positive electrode 11 on the stacked unit 305 side up to the stacking position and raising the support 311 on the positive electrode supplying conveyor 303 side by the movement amount 1 each time one separator-attached positive electrode 11 is supplied from the positive electrode supplying conveyor 303. In control of the driving units 312 and 315, a difference between the stacking operation and the return operation is that the former corresponds to an operation state in which the drive gear 406a is stopped and the latter rotates the drive gear 406a. The drive gear 406a continues to rotate until the height position of the support 311 at the head supporting the separator-attached positive electrode 11 is set as the stacking position. When the return operation is performed, it is possible to execute the extrusion operation of simultaneously extruding the four separator-attached positive electrodes 11 using the extrusion unit 321 while receiving the separator-attached positive electrode 1 supplied from the positive electrode supplying conveyor 303. Therefore, after completion of the return operation of the circulating member 310, the controller 350 switches the circulating member 310 to the stacking operation (step S206→S203).

In the electrode stacking device 300 according to the present embodiment, the controller 350 repeatedly executes the first extrusion operation, the first movement operation, the second extrusion operation, and the second movement operation described with reference to FIG. 6 and FIG. 7. In the present flowchart, as illustrated in FIG. 10 to FIG. 12, a description will be given of an example in the case of “n=2” and “m=4”. Therefore, the first extrusion operation corresponds to processing of S203 (stacking operation) and S204, and the first movement operation of lowering the support 311 by one level corresponds to processing of S206 (return operation). Further, the second extrusion operation corresponds to processing of S203 (stacking operation) and S204 executed again, and the second movement operation of lowering the support 311 by seven levels corresponds to S206 (return operation) executed again. In this way, in the present embodiment, in the return operation of S206, two types of operations corresponding to the first movement operation of lowering the support 311 by one level and the second movement operation of lowering the support 311 by seven levels are seemingly performed.

A detailed description will be given of the return operation at the time of the first movement operation of lowering the support 311 by one level. For the sake of easy understanding, it is presumed that the separator-attached positive electrode 11 is supplied without any defect. The controller 350 circulates the circulating member 310 clockwise by the movement amount 1 in the unit time described above. In this way, in the unit time, on the positive electrode supplying conveyor 303 side, the support 311 rises one corresponding level with respect to the positive electrode supplying conveyor 303. Meanwhile, on the stacked unit 305 side, the support 311 lowers one corresponding level with respect to the stacked unit 305. In this way, it is possible to execute the extrusion operation of simultaneously extruding four separator-attached positive electrodes 11 of subsequent levels using the extrusion unit 321 while receiving the separator-attached positive electrode 11 supplied from the positive electrode supplying conveyor 303.

A detailed description will be given of the return operation at the time of the second movement operation of lowering the support 311 by seven levels. In the unit time described above, the controller 350 circulates the circulating member 310 clockwise by a movement amount 4 and lowers the circulating member 310 by a movement amount 3 (see FIG. 12). In this way, in the unit time, on the positive electrode supplying conveyor 303 side, the support 311 rises one corresponding level with respect to the positive electrode supplying conveyor 303. Meanwhile, on the stacked unit 305 side, the support 311 lowers seven corresponding levels with respect to the stacked unit 305. In this way, it is possible to execute the extrusion operation of simultaneously extruding four separator-attached positive electrodes 11 of subsequent levels using the extrusion unit 321 while receiving the separator-attached positive electrode 11 supplied from the positive electrode supplying conveyor 303.

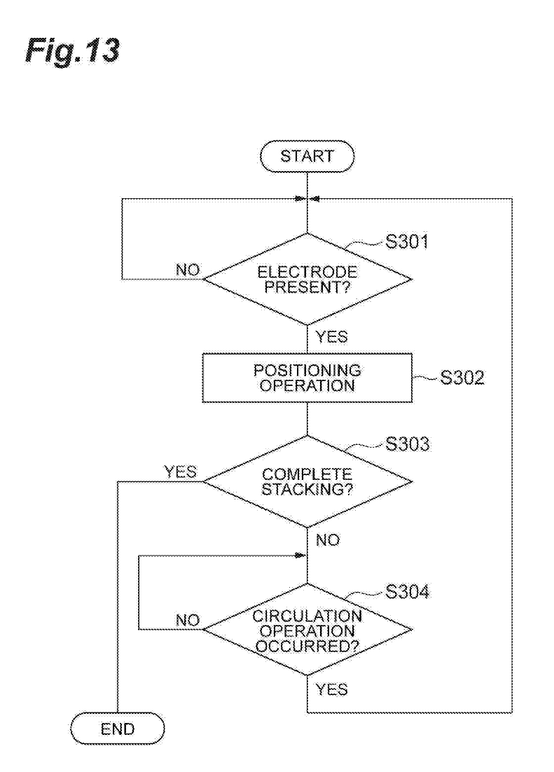

Next, a description will be given of a control flow of the positioning units 47 and 48 with reference to FIG. 13. FIG. 13 is a flowchart illustrating a control flow common to the positioning unit 47 (see FIG. 5) of the positive electrode conveying unit 301 and the positioning unit 48 (see FIG. 5) of the negative electrode conveying unit 302. Here, as an example, a description will be given of control of the positioning unit 47. The control flow of the positioning unit 48 is similar to the control flow of the positioning unit 47, and thus a description thereof will be omitted.

In FIG. 13, the controller 350 verifies whether an electrode (here, the separator-attached positive electrode 11) is present at a position at which positioning by the positioning unit 47 is allowed by periodically checking presence or absence of reception of a detection signal from the stacking position sensor 308 (step S301). The controller 350 continues checking described above until the detection signal from the stacking position sensor 308 is received (step S301: NO). Upon receiving the detection signal from the stacking position sensor 308 and detecting that the support 311 supporting the separator-attached positive electrode 11 has reached the stacking position (step S301: YES), the controller 350 causes the positioning unit 47 to execute a positioning operation (step S302). Specifically, as described in the first embodiment, the controller 350 performs a control operation to execute a pressing operation by the pressing portion 54 of the positioning unit 47. Such a positioning operation has been described in the first embodiment, and thus a further detailed description will be omitted.

Subsequently, the controller 350 determines whether to complete stacking by determination similar to that of step S205 of FIG. 9 described above (step S303). When it is determined to complete stacking (step S303: YES), the controller 350 ends control of the positioning unit 47. On the other hand, when it is not determined to complete stacking (step S303: NO), the controller 350 suspends the operation of the positioning unit 47 until the circulation operation (that is, the return operation of the circulating member 310 described above) in which the height position of the support 311 on the stacked unit 305 side changes relative to the stacked unit 305 occurs (step S304: NO). Upon confirming that the circulation operation has occurred (that is, when the controller 350 switches the circulating member 310 to the return operation), the controller 350 returns to step S301 and continues the control of the positioning unit 47 (step S304: YES).

In determination to cause the positioning unit 47 to execute the positioning operation, a determination criterion other than a determination criterion used in the above determination may be used. For example, the fact that the extrusion unit 321 stops may be added as a determination condition for executing the positioning operation of step S302.

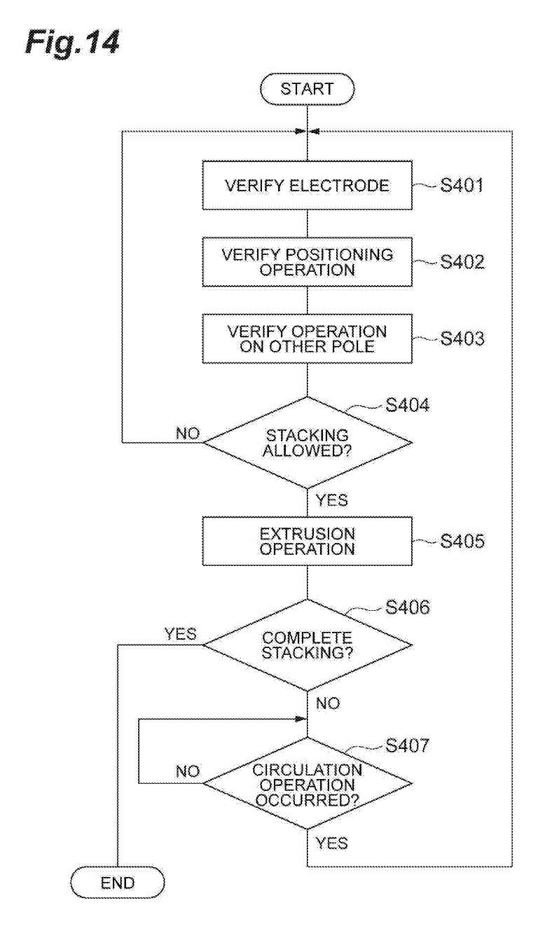

Next, a description will be given of a control flow of the extrusion unit 321 with reference to FIG. 14. FIG. 14 is a flowchart illustrating the control flow of the extrusion unit 321.

In FIG. 14, the controller 350 verifies whether the support 311 supporting the separator-attached positive electrode 11 is present at the stacking position based on a detection signal received from the stacking position sensor 308 (step S401). In addition, the controller 350 verifies whether the positioning operation by the positioning unit 47 (step S302 of FIG. 13) has been completed (step S402). For example, the controller 350 can verify the positioning operation of the positioning unit 47 has been completed by confirming that the pressing portion 54 of the positioning unit 47 has returned to the original position (position before pressing). In addition, the controller 350 verifies whether stacking of the negative electrode 9 (discharge to the stacked portion 316) has been completed in the negative electrode conveying unit 302 on the other pole side (here, the negative electrode 9 side) (step S403). For example, the controller 350 can confirm that stacking of the negative electrode 9 has been completed by confirming that the extrusion operation of the extrusion unit 322 of the negative electrode conveying unit 302 has been completed and the pushing members 322a have returned to the original positions (positions before performing the extrusion operation).

The controller 350 determines whether stacking is allowed (that is, whether the extrusion operation by the pushing members 321a of the extrusion unit 321 is executable) based on verification results of the above-described steps S401 to S403 (step S404). Specifically, in the case of being able to confirm that the support 311 supporting the separator-attached positive electrode 11 is present at the stacking position, the positioning operation by the positioning unit 47 has been completed, and stacking of the negative electrode 9 has been completed, the controller 350 determines that stacking is allowed (step S404: YES). On the other hand, in the case of not being able to confirm at least one of verification items, the controller 350 determines that stacking is not allowed (step S404: NO) and returns to step S401.

Subsequently, when it is determined that stacking is allowed (step S404: YES), the controller 350 executes the extrusion operation by the extrusion unit 321 (step S405). Specifically, the controller 350 controls the driving unit so that four separator-attached positive electrodes 11 are simultaneously extruded toward stacked portions 316 of four upper and lower levels using the pushing members 321a in the extrusion unit 321.

Subsequently the controller 350 determines whether to complete stacking by determination similar to that of step S205 of FIG. 9 described above (step S406). When it is determined to complete stacking (step S406: YES), the controller 350 ends control of the extrusion unit 321. On the other hand, when it is not determined to complete stacking (step S406: NO), the controller 350 suspends the operation of the extrusion unit 321 until the circulation operation in which the height position of the support 311 on the stacked unit 305 side changes relative to the stacked unit 305 (that is, the return operation of the circulating member 310 described, above) occurs (step S407: NO). When it is confirmed that the circulation operation has occurred (that is, when the controller 350 switches the circulating member 310 to the return operation), the controller 350 returns to step S401 and continues control of the extrusion unit 321 (step S407: YES).

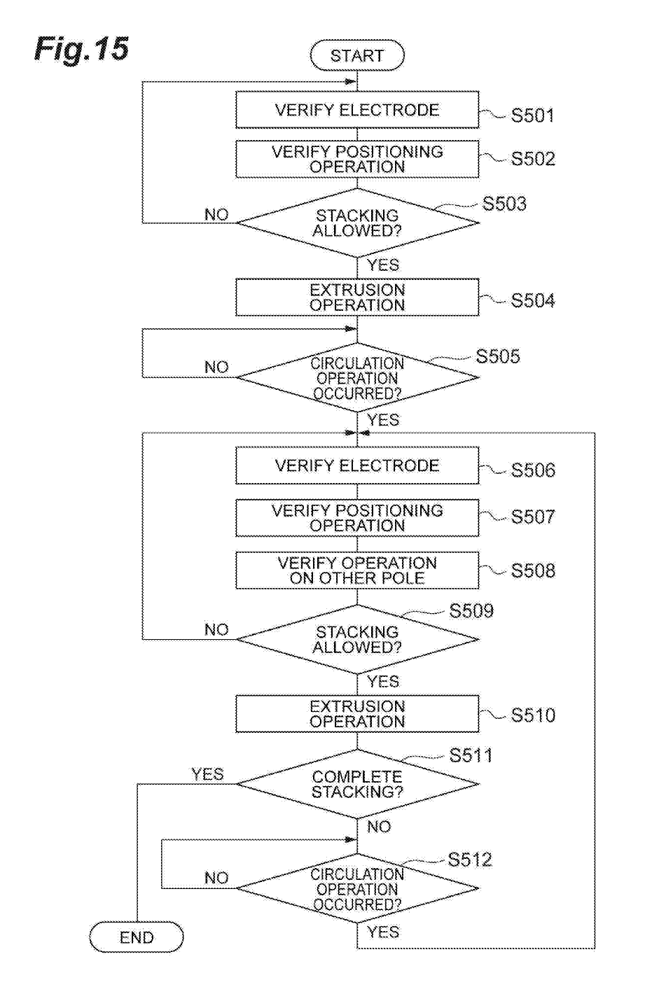

Next, a description will be given of a control flow of the extrusion unit 322 with reference to FIG. 15. FIG. 15 is a flowchart illustrating the control flow of the extrusion unit 322. In the present embodiment, as an example, it is defined that the negative electrode 9 is first stacked on the stacked portion 316. For this reason, in the control flow of the extrusion unit 322 of the negative electrode 9, a control flow (steps S501 to S505) in a case in which a first negative electrode 9 is stacked on the stacked portion 316 is partially different from a control flow (steps S506 to S512) in a case in which second and subsequent negative electrodes 9 are stacked on stacked portions 316.

Specifically, since the negative electrode 9 is first stacked on the stacked portion 316, when the first negative electrode 9 is stacked on the stacked portion 316, it is unnecessary to check an operation on the separator-attached positive electrode 11 side. For this reason, in the control flow (steps S501 to S505) in a case in which the first negative electrode 9 is stacked on the stacked portion 316, checking of an operation on the other pole side (step corresponding to step S403 of FIG. 14) is omitted. In addition, in a state in which only one negative electrode 9 is stacked, stacking is not completed, and thus determination as to whether stacking is completed (step corresponding to step S406 of FIG. 14) is also omitted.

Meanwhile, the control flow (steps S506 to S512) in a case in which the second and subsequent negative electrodes 9 are stacked on the stacked portions 316 is similar to the control flow of the extrusion unit 321 described above (steps S401 to 407 of FIG. 14).

The above-described electrode stacking device 300 is a device that stacks the electrodes (the separator-attached positive electrode 11 and the negative electrode 9) supplied by the positive electrode supplying conveyor 303 (conveying device) and the negative electrode supplying conveyor 304 (conveying device) and forms a stacked body (electrode stacked body formed on each stacked portion 316). The electrode stacking device 300 includes the supports 311 and 314 (electrode supports), the circulating members 310 and 313, the stacked unit 305, the extrusion units 321 and 322, and the controller 350 (control unit). The supports 311 and 314 receive the separator-attached positive electrode 11 and the negative electrode 9 supplied by the positive electrode supplying conveyor 303 and the negative electrode supplying conveyor 304, and support the separator-attached positive electrode 11 and the negative electrode 9. The circulating members 310 and 313 form loop shapes extending in the vertical direction, and the supports 311 and 314 are attached to the outer peripheral surfaces thereof. The stacked unit 305 is disposed on the opposite side of the circulating member 310 from the positive electrode supplying conveyor 303, is disposed on the opposite side of the circulating member 313 from the negative electrode supplying conveyor 304, and has the stacked portions 316 of the plurality of levels on which the separator-attached positive electrode 11 and the negative electrode 9 are stacked. The extrusion unit 321 simultaneously extrudes the separator-attached positive electrodes 11 supported by the plurality of supports 311 toward the stacked portions 316 of the plurality of levels. The extrusion unit 322 simultaneously extrudes the negative electrodes 9 supported by the plurality of supports 314 toward the stacked portions 316 of the plurality of levels. The controller 350 controls circulation and raising/lowering of the circulating members 310 and 313 and operations of the extrusion units 321 and 322 (that is, operations of the pushing members 321a and 321b). The controller 350 controls the operation of the extrusion unit 321 to extrude the separator-attached positive electrode 11 toward the stacked portion 316 at a lower speed than a conveying speed of the separator-attached positive electrode 11 by the positive electrode supplying conveyor 303. Further, the controller 350 controls the operation of the extrusion unit 22 to extrude the negative electrode 9 toward the stacked portion 316 at a lower speed than a conveying speed of the negative electrode 9 by the negative electrode supplying conveyor 304.

In the electrode stacking device 300, the electrodes (the separator-attached positive electrodes 11 or the negative electrodes 9) successively supplied to the supports 311 and 314 are simultaneously extruded and stacked on different stacked portions 316, respectively. In this way, when a larger number of electrodes than the number of successively supplied electrodes are simultaneously extruded and stacked, a discharge speed at the time of extruding the electrodes to the stacked portions 316 can be set to be slower than a conveying speed (supply speed) of the electrodes by the conveying device (the positive electrode supplying conveyor 303 or the negative electrode supplying conveyor 304). In this way, it is possible to suppress a position shift of the electrode at the time of stacking the electrode while preventing a pace at which the electrode is stacked from being lowered. Therefore, according to the electrode stacking device 300, it is possible to achieve a high stacking speed while suppressing upsizing of the device.

In addition, the conveying speed of the electrodes by the conveying device (the positive electrode supplying conveyor 303 or the negative electrode supplying conveyor 304) becomes higher than the discharge speed of the electrodes. For this reason, when electrodes conveyed at a high speed stop on the supports 311 and 314, a position shift occurs. When a large number of electrodes are stacked in a state of having a position shift, aligning again after stacking is difficult due to friction of a surface such as a negative electrode active material layer. However, electrodes on the supports 311 and 314 are in a state of individual pieces before a large number of electrodes are stacked on the stacked portion 316, and thus positions thereof are easily corrected by inversion by the circulating members 310 and 313 and action of the positioning unit 47.

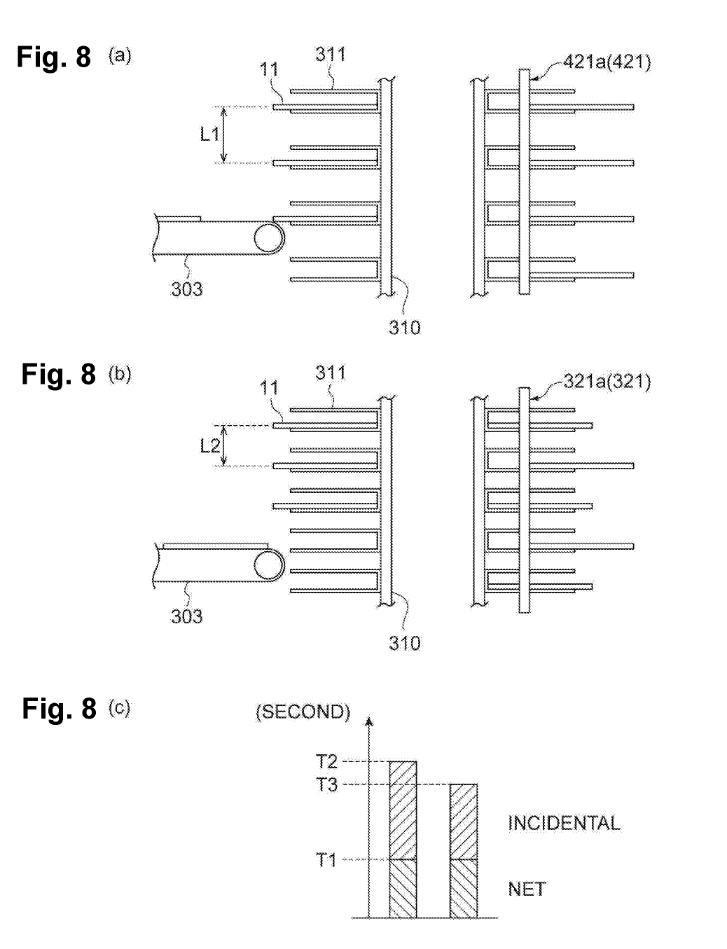

Here, a description will be given of a case in which a pushing member 421a simultaneously extrudes a continuous number of levels of electrodes without skipping a support 311 with reference to FIG. 8(a). In this case, when an interval L1 between supports 311 is attempted to be decreased, an interval between electrodes extruded on a stacking side is also decreased. In this instance, an interval between stacked portions 316 cannot be decreased more than a certain value to ensure a thickness of the stacked body in some cases. Alternatively, there is also a possibility that stacking accuracy may decrease when stacking is performed in a state in which a sufficient space cannot be ensured. Therefore, it may be difficult to decrease the interval L1 between the supports 311 to ensure an interval between extruded electrodes in some cases.

On the other hand, in the present embodiment, the pushing members 321a and 322a extrude electrodes at one interval with respect to the supports 311 and 314 per n levels. As described above, the pushing members 321a and 322a can extrude electrodes by skipping (n−1) levels with respect to a plurality of supports 311 and 314. In this way, it is possible to shorten an interval at which electrodes are received by decreasing an interval L2 between the supports 311 and between the supports 314. Meanwhile, on the stacked portion 316 side, the stacked portion 316 can be disposed by skipping (n−1) levels with respect to the plurality of supports 311 and 314, and thus it is possible to accurately discharge each electrode to the stacked portion 316 in a state in which a sufficient space is ensured between simultaneously extruded electrodes (see FIG. 8(b)). For example, as illustrated in FIG. 8(c), a net time T1 is invariably required for an operation in which electrodes are transferred to the supports 311 and 314. Meanwhile, a time required for moving the supports 311 and 314, etc. is incidental. Therefore, as illustrated in FIG. 8(a), when the interval L1 between the supports 311 and between the supports 314 is large, an incidental time 12 is required. On the other hand, in FIG. 8(b), a moving distance of the supports 311 and 314 can be shortened by decreasing the interval L2, and thus an incidental time 13 can be set to be shorter than T2. Therefore, it is possible to shorten a time (T1+T2) as an entire transfer operation. In this way, it is possible to further increase the stacking speed while ensuring the stacking accuracy. As described above, according to the electrode stacking device 300, it is possible to achieve a high stacking speed while suppressing upsizing of the device.

The stacked unit 305 has the stacked portion 316 at one interval with respect to the supports 311 and 314 per n levels. In this case, electrodes can be accurately received by the stacked portion 316 corresponding to an interval of the electrodes extruded by the pushing members 321a and 322a.

The controller 350 that controls circulation of the circulating members 310 and 313 and operations of the pushing members 321a and 322a is further included, and the controller 350 executes the first extrusion operation (first discharge operation) of extruding m electrodes among the electrodes supported by the supports 311 and 314 using the pushing members 321a and 322a, the first movement operation of moving the circulating members 310 and 313 with respect to the pushing members 321a and 322a in the circulation direction by one level of the supports 311 and 314, and the second extrusion operation (second discharge operation) of extruding m electrodes using the pushing members 321a and 322a after the first movement operation and executes the second movement operation of moving the circulating members 310 and 313 with respect to the pushing members 321a and 322a in the circulation direction by {m×n−(n'1)} levels of the supports 311 and 314 after executing the first movement operation and the second extrusion operation (n−1) times. In this way, it is possible to smoothly interlock extrusion by the pushing members 321a and 322a with circulation of the circulating members 310 and 313.

A pair of conveying units, each of which includes an electrode support, a circulating member, and an extrusion portion, is provided with the stacked unit 305 interposed therebetween, the positive electrode conveying unit 301 conveys a separator-attached positive electrode 11 obtained by forming a positive electrode active material layer on a surface of a positive electrode current collector, and the negative electrode conveying unit 302 conveys a negative electrode 9 obtained by forming a negative electrode active material layer on a surface of a negative electrode current collector. In this way, when the conveying units 301 and 302 are adopted on both the positive electrode side and the negative electrode side, it is possible to achieve a higher stacking speed of the positive electrode and the negative electrode.

Even though several embodiments of the invention have been described above, the invention is not limited to the embodiments.

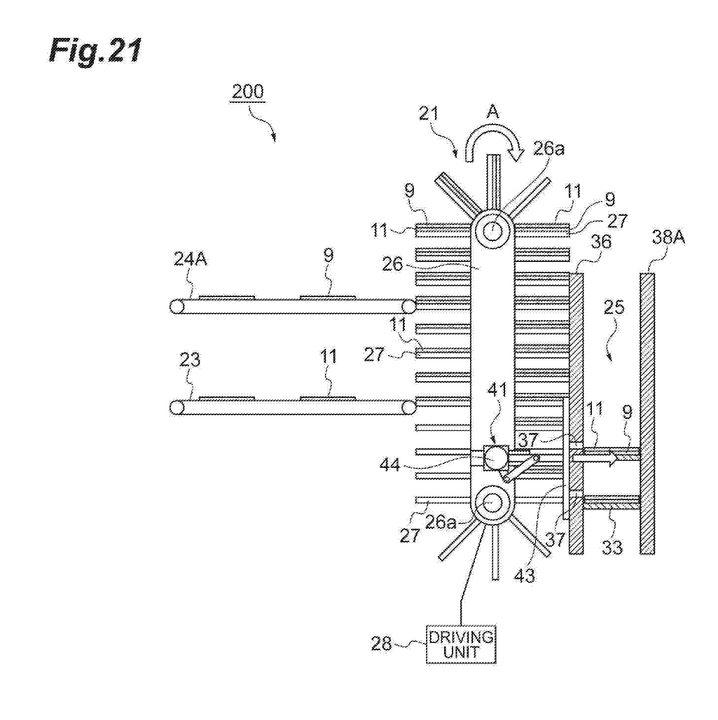

For example, an electrode stacking device 200 illustrated in FIG. 21 may be adopted. In the electrode stacking device 200, a positive electrode conveying unit 21 conveys the negative electrode 9 together with the separator-attached positive electrode 11, and the negative electrode conveying unit 302 is omitted. In addition, instead of the negative electrode supplying conveyor 304, the electrode stacking device 200 includes a negative electrode supplying conveyor 24A for supplying the negative electrode 9 to the positive electrode conveying unit 21. In addition, the electrode stacking device 200 includes a wall 38A in which no slit is formed. Other configurations of the electrode stacking device 200 are similar to those of the electrode stacking device 300.

The negative electrode supplying conveyor 24A is disposed above a positive electrode supplying conveyor 23. That is, the negative electrode supplying conveyor 24A is disposed on a downstream side of a supply position at which the separator-attached positive electrode 11 is supplied by the positive electrode supplying conveyor 23 in a circulation path formed by circulation of a circulating member 26. According to such arrangement, the negative electrode supplying conveyor 24A supplies the negative electrode 9 to a support 27 that supports the separator-attached positive electrode 11 supplied from the positive electrode supplying conveyor 23. Specifically, the negative electrode supplying conveyor 24A supplies the negative electrode 9 such that the negative electrode 9 overlaps the separator-attached positive electrode 11 supported by the support 27 thereon.

As described above, in the electrode stacking device 200, a set of one separator-attached positive electrode 11 and one negative electrode 9 (hereinafter referred to as an “electrode set”) is supported by each support 27 and conveyed. In such a configuration, a controller controls a driving unit 28 to hold two electrode sets conveyed by the positive electrode conveying unit 21 at height positions corresponding to stacked portions 33 of two upper and lower levels.

For example, in the above embodiment, the separator-attached positive electrode 11 in a state in which the positive electrode 8 is wrapped in the bag-shaped separator 10 and the negative electrode 9 are alternately stacked on the stacked portions. However, the invention is not particularly limited to this mode, and a positive electrode and a separator-attached negative electrode in a state in which the negative electrode is wrapped in a bag-shaped separator may be alternately stacked on stacked portions.

In addition, the above embodiment adopts a structure in which motors are disposed on the supplying conveyor side and the stacked unit side, respectively, as the driving units 312 and 315 and the timing belt is wound. However, the invention is not limited to this structure. For example, a combination of a motor fixed to a circulation frame to rotatably drive one of sprockets and a motor fixed to a support frame to vertically move the circulation frame through a ratchet mechanism, etc. may be adopted.

In addition, in the above embodiment, the stacked portion 316 includes the U-shaped side wall 316b. However, a structure in which right and left parts facing the wall 317 from the side wall 316b are omitted and positioning is directly performed by the wall 317 may be adopted.

In addition, in the above embodiment, the positioning units 47 and 48 are included. However, it is also possible to use another positioning means. For example, a structure in which a guide plate having tapered surfaces on both sides thereof is disposed along the circulation path of the support 311 and a position of an electrode is guided to a center of the support 311 as the support 311 lowers may be adopted.

In addition, in the above embodiment, a description has been given of operation content for completing circulation or vertical movement per unit time. However, the invention is not particularly limited thereto. For example, with regard to the second movement operation of the return operation, when the support 311 on the stacked unit 305 side is moved by seven levels, the support 311 may be moved over two unit times.

In addition, with regard to extrusion of the electrodes 11 and 9 to the stacked portions 316, a description has been given in the above embodiment without overlapping periods. However, for example, a partial period of the extrusion operation may be overlapped.

Further, in the above embodiment, the power storage device 1 corresponds to the lithium ion secondary battery. However, the invention is not particularly limited to the lithium ion secondary battery, For example, the invention is applicable to another secondary battery such as a nickel hydride battery and stacking of electrodes in a power storage device such as an electric double layer capacitor or a lithium ion capacitor.

Here, the above embodiment has described that the pushing members “simultaneously” extrude the plurality of electrodes to the stacked portions 316. The expression “simultaneously” in this specification means that respective electrodes are discharged in a time range after positioning of the plurality of electrodes with respect to the stacked portions 316 is completed and discharge of all discharge target electrodes to the stacked portions 316 is completed and before a subsequent process (for example, circulation of the circulating member) is started. That is, in addition to a case in which all the electrodes are discharged perfectly at the same timing, a case in which a slight shift occurs in discharge timings of the respective electrodes within the above-described limited time range corresponds to “simultaneously”.

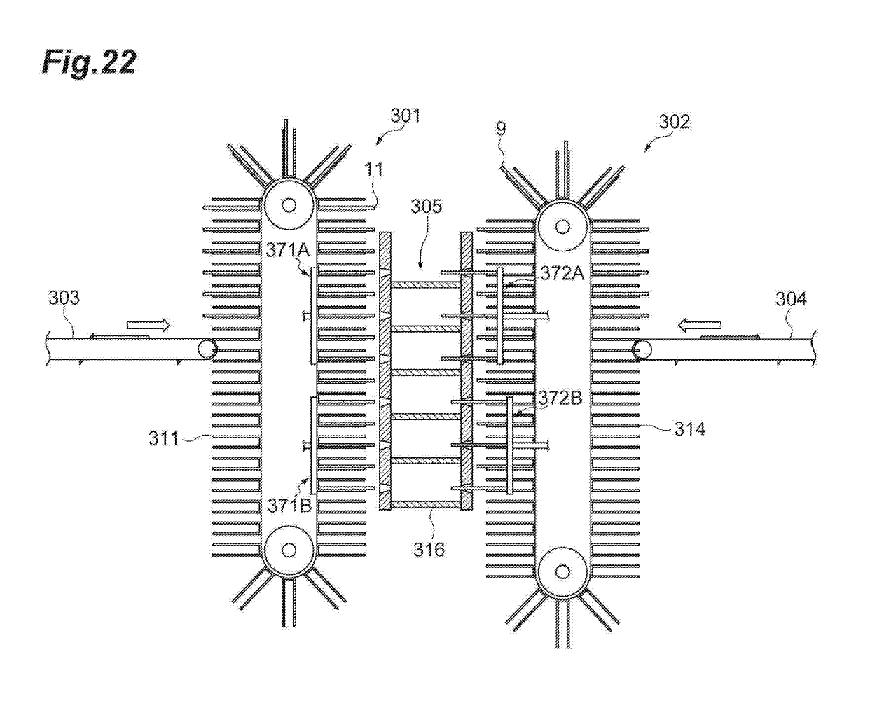

For example, in an example illustrated in FIG. 22, an electrode stacking device includes a discharge member 371A and a discharge member 371B as a discharge portion that discharges separator-attached positive electrodes 11 supported by a plurality of electrode supports toward stacked portions 316 of a plurality of levels. The discharge member 3714 and the discharge member 371B are members that discharge some (here, half) of a plurality of separator-attached positive electrodes 11 discharged in one discharge process. The discharge member 371A and the discharge member 371B are provided to be aligned in the vertical direction. In addition, the electrode stacking device includes discharge members 372A and 372B as a discharge portion that discharges negative electrodes 9 supported by a plurality of electrode supports toward stacked portions 316 of a plurality of levels. The discharge member 372A and the discharge member 372B are members that discharge some (here, half) of a plurality of negative electrodes 9 discharged in one discharge process. The discharge member 372A and the discharge member 372B are provided to be aligned in the vertical direction. A timing at which the discharge members 371A and 372A discharge the electrodes 11 and 9 may be shifted from a timing at which the discharge members 371B and 372B discharge the electrodes 11 and 9 within the above-described time range.

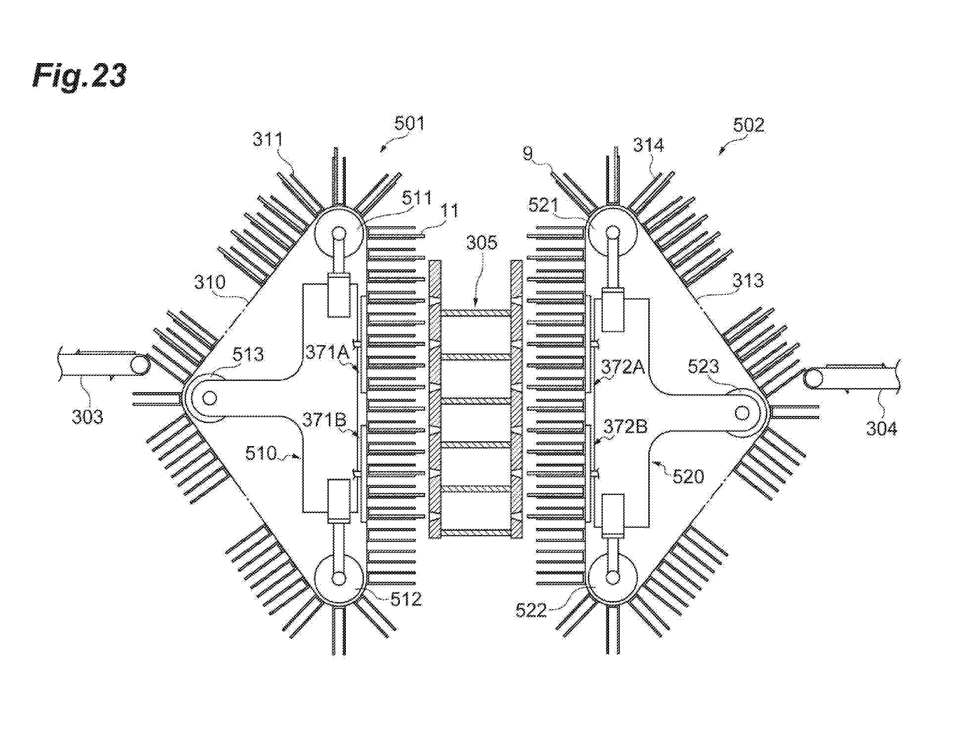

In addition, the above embodiment illustrates a unit in which the circulating member forms a loop shape in the vertical direction as a circulation unit. However, a configuration of the circulation unit is not particularly limited. For example, it is possible to adopt circulation units 501 and 502 illustrated in FIG. 23. The circulation unit 501 includes a frame 510 having a rotating portion 511 disposed on an upper side, a rotating portion 512 disposed on a lower side, and a rotating portion 513 disposed on a positive electrode supplying conveyor 303 side. A circulating member 310 is supported by the respective rotating portions 511, 512, and 513 to form a triangular loop. The circulation unit 502 includes a frame 520 having a rotating portion 521 disposed on an upper side, a rotating portion 522 disposed on a lower side, and a rotating portion 523 disposed on a negative electrode supplying conveyor 304 side. A circulating member 313 is supported by the respective rotating portions 521, 522, and 523 to form a triangular loop.

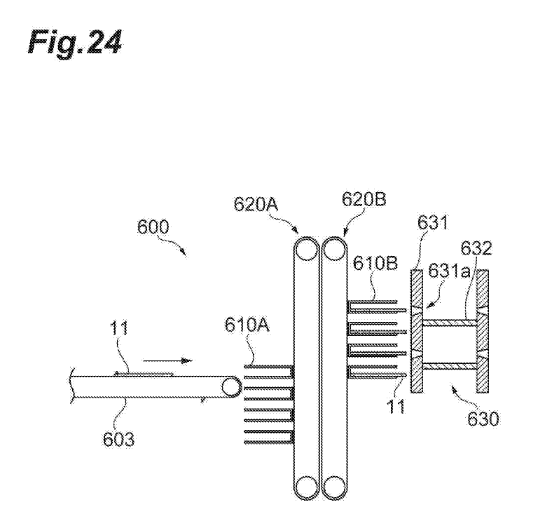

In addition, the above embodiment has described the electrode stacking device having a servo loop type driving scheme. However, a driving scheme of the electrode stacking device is not particularly limited. For example, it is possible to adopt an electrode stacking device 600 illustrated in FIG. 24 to FIG. 29. The electrode stacking device 60 includes a conveying device 603 that conveys the separator-attached positive electrodes 11, electrode supports 610A and 610B that supports the separator-attached positive electrodes 11, mounting members 620A and 620B to which the electrode supports 610A and 610B are attached, and a stacked unit 630 having stacked portions 632 of a plurality of levels on which the separator-attached positive electrodes 11 are stacked. The mounting members 620A and 620B can move the electrode supports 610A and 610B in the vertical direction and includes a conveyor, etc. extending in the vertical direction. However, a driving scheme in which the mounting members 620A and 620B vertically move the electrode supports 610A and 610B is not limited to the conveyor, and any driving scheme may be adopted. For example, the electrode supports 610A and 610B may be provided with a driving device and moved while being guided by the mounting members 620A and 620B. The mounting members 620A and 620B are provided to face each other, the electrode support 610A is provided on one side in a facing direction of the mounting member 620A, and the electrode support 610B is provided on the other side in a facing direction of the mounting member 620B. A discharge portion (not illustrated) that discharges the separator-attached positive electrodes 11 is provided in the electrode supports 610A and 610B.

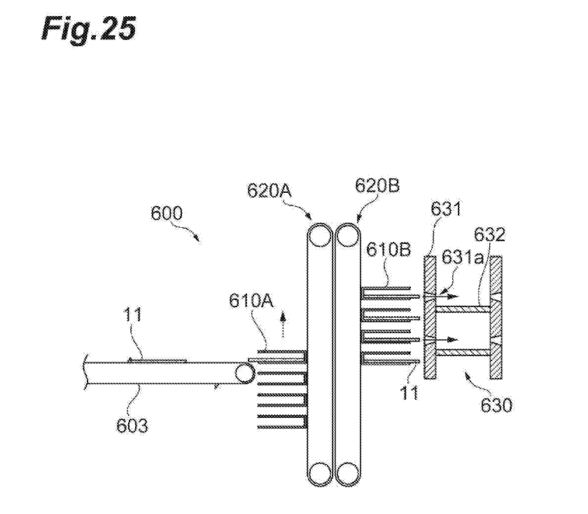

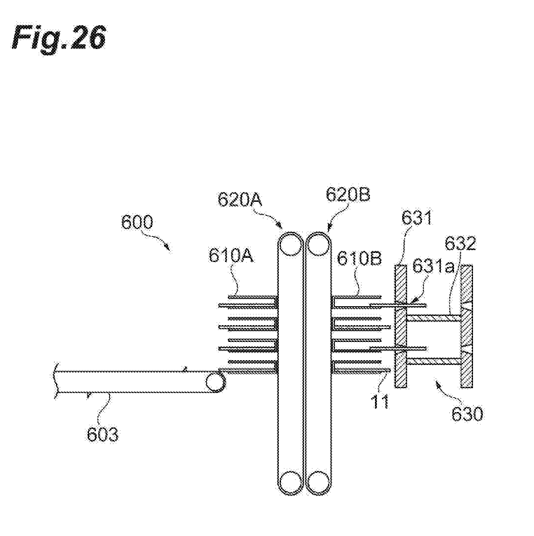

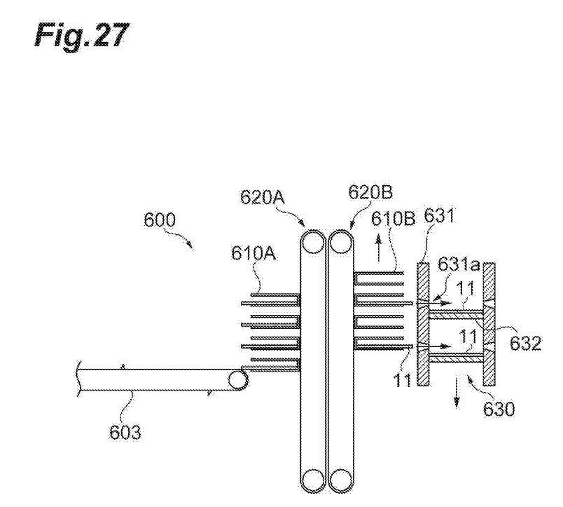

First, in a state illustrated in FIG. 24, the electrode support 610A is disposed on the conveying device 603 side and is prepared to receive the separator-attached positive electrodes 11 from the conveying device 603. The electrode support 610B is disposed on the stacked unit 630 side. The electrode support 610B is in a state of supporting the separator-attached positive electrodes 11. As illustrated in FIG. 25, the electrode support 610A supports the separator-attached positive electrodes 11 supplied from the conveying device 603. The mounting member 620A supplies the separator-attached positive electrode 11 to each electrode support 610 by moving the electrode support 610A level by level each time the separator-attached positive electrode 11 is supplied. Meanwhile, as illustrated in FIG. 25 and FIG. 26, on the electrode support 610B side, the discharge portion (not illustrated) discharges a separator-attached positive electrode 11 at one interval with respect to an electrode support 610B per level. In this way, the separator-attached positive electrode 11 is discharged to a stacked portion 632 through a slit 631a of a wall 631. Upon completion of discharge, as illustrated in FIG. 27, the mounting member 620B moves the electrode support 610B by one level and discharges remaining separator-attached positive electrodes 11 to respective stacked portions 632.

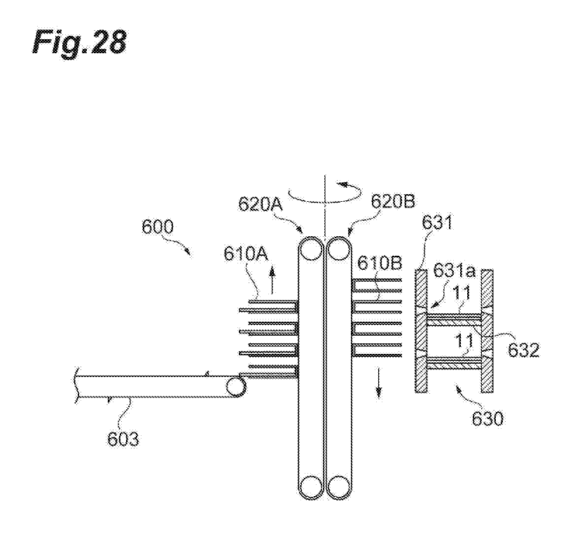

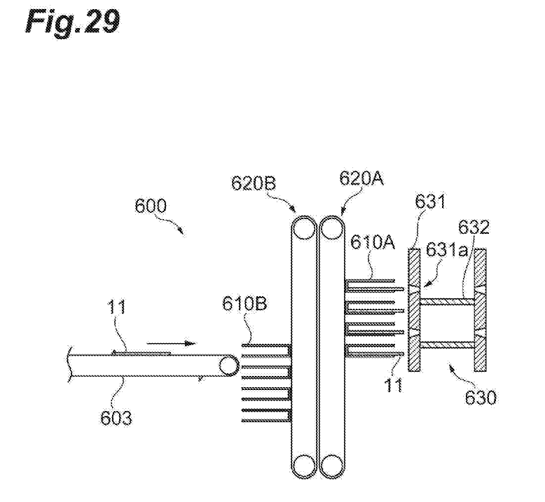

After discharge of the separator-attached positive electrodes 11 on the electrode support 610B side is completed, as illustrated in FIG. 28 and FIG. 29, the mounting members 620A and 620B rotate by 180°. In this way, the separator-attached positive electrode 11 is supplied from the conveying device 603 to the electrode support 610E after discharging the separator-attached positive electrode 11. The electrode support 610A, to which supply of the separator-attached positive electrode 11 is completed, supplies the separator-attached positive electrode 11 to each stacked portion 632. Supply and discharge of the separator-attached positive electrode 11 are performed in the same procedure as described above. Thereafter, this operation is repeated.

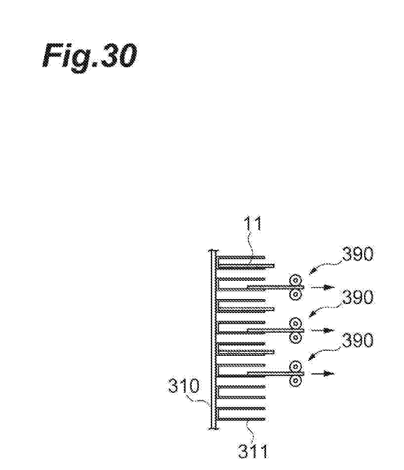

In addition, in the above embodiment, an extruding member is adopted as a discharge portion of an electrode supported by an electrode support. However, a discharge scheme of the discharge portion is not particularly limited, and any structure can be adopted as long as the structure can discharge an electrode. For example, as illustrated in FIG. 30, a nip roll 390 may be disposed from a lateral side in front of the support 311 at the time of discharging an electrode, and the separator-attached positive electrode 11 may be discharged by being drawn using the nip roll 390. In addition, an arm, etc. for drawing an electrode may be used as the discharge portion.

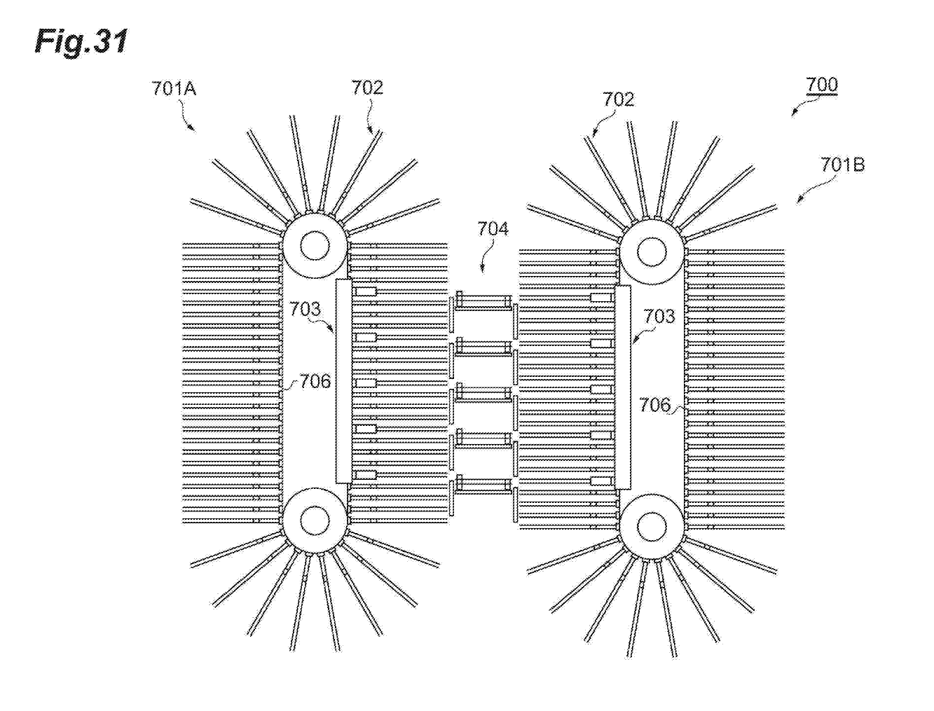

In addition, as a modification, it is possible to adopt an electrode stacking device 700 illustrated in FIG. 31 to FIG. 33. As illustrated in FIG. 31, the electrode stacking device 700 includes a positive electrode conveying unit 701A, a negative electrode conveying unit 701B, and a stacked unit 704. In addition, the electrode stacking device 700 includes a conveyor (not illustrated) for supply of electrodes having the same purpose as that of the positive electrode supplying conveyor 303 and the negative electrode supplying conveyor 304. Each of the positive electrode conveying unit 701A and the negative electrode conveying unit 701B includes a support 702 attached to a circulating member 706, an extrusion unit 703 that extrudes and discharges an electrode supported by the support 702, and a stacked unit 704.

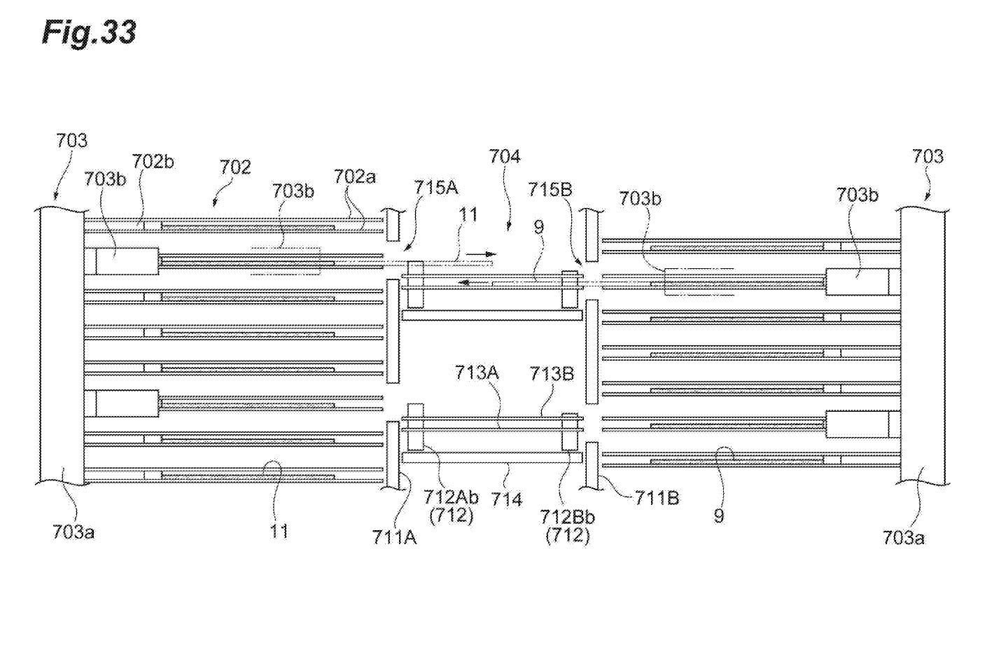

As illustrated in FIG. 33, the support 702 includes a bracket 702b provided on the circulating member 706 and a pair of plates 702a provided to interpose the bracket 702b therebetween.

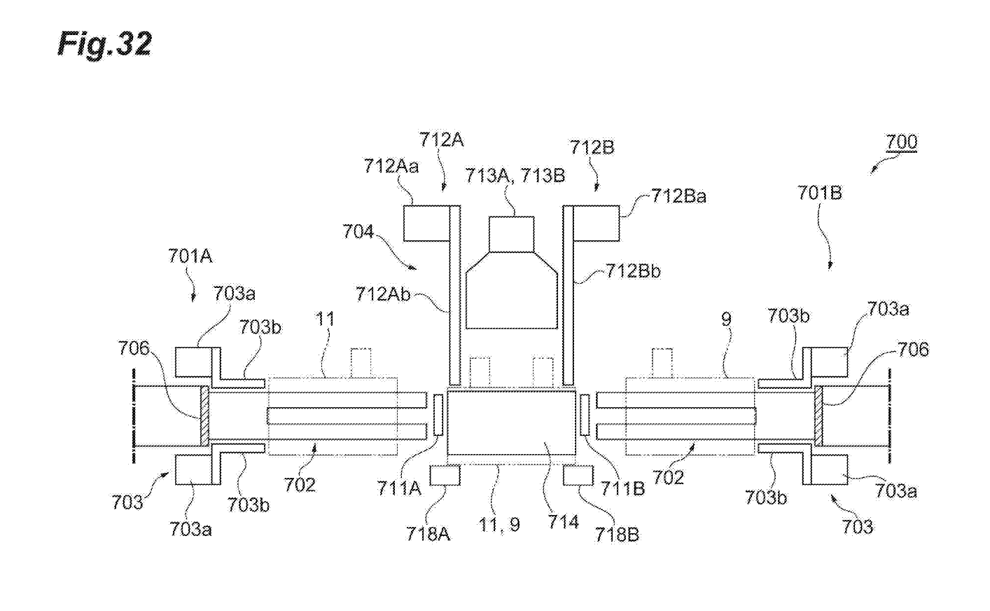

As illustrated in FIG. 32 and FIG. 33, the extrusion unit 703 of the electrode stacking device 700 according to the present modification includes a base body 703a that extends in the vertical direction and a comb-shaped extrusion portion 703b provided at a predetermined pitch in the vertical direction with respect to the base body 703a. A pair of the base body 703a and the extrusion portion 703b is provided on a rear end side in a discharge direction of the separator-attached positive electrode 11 with a support 702 interposed therebetween, and a pair of the base body 703a and the extrusion portion 703b is provided on a rear end side in a discharge direction of the negative electrode 9 with a support 702 interposed therebetween. The extrusion portion 703b is provided to extend along a side edge of the support 702. The extrusion portion 703b is provided on the base body 703a at one interval with respect to supports 702 per n levels (here, n=4).

The stacked unit 704 includes a stacked portion 714, walls 711A and 711B, partition plates 713A and 71313, positioning portions 712A and 712B, and receiving portions 718A and 718B. A slit 715A for discharging the separator-attached positive electrode 11 to the stacked portion 714 side is formed in the wall 711A. A slit 715B for discharging the negative electrode 9 to the stacked portion 714 side is formed in the wall 711B. The slit 715A is formed at a position higher than the slit 715B by one level of the supports 702 in the vertical direction. Each of the walls 711A and 711B is supported by a support structure (not illustrated). Each support structure includes a base body extending in the vertical direction and a support extending from the base body toward the walls 711A and 711B. The support structure is provided around the positioning portions 712A and 712B not to interfere with the positioning portions 712A and 712B. In addition, the stacked portion 714 is supported by the support structure (not illustrated). The support structure supports parts of edges of the stacked portion 714 around the receiving portions 718A and 718B, respectively, not to interfere with the receiving portions 718A and 718B. The support structure includes a pair of base bodies extending in the vertical direction and a support extending from the base bodies toward a support position of the stacked portion 714.

The partition plate 713A is a member that temporarily holds the separator-attached positive electrode 11 discharged from the slit 715A to the stacked portion 714 side above the stacked portion 714. The partition plate 713B is a member that temporarily holds the negative electrode 9 discharged from the slit 715B to the stacked portion 714 side above the stacked portion 714. When the electrodes 11 and 9 are placed on the partition plates 713A and 713B, the partition plates 713A and 713B move to be extracted from a position hieing the stacked portion 714 (state illustrated in FIG. 32). In this instance, the positioning portions 712A and 712B support the electrodes 11 and 9 placed on the partition plates 713A and 713B in an extracting direction. In this way, when the partition plates 713A and 713B are extracted, it is possible to prevent the electrodes 11 and 9 from moving together with the partition plates 713A and 713B. After the partition plates 713A and 713B are extracted, the electrodes 11 and 9 drop downward and are stacked on the stacked portion 714.

The positioning portions 712A and 712B are members that perform positioning of the electrodes 11 and 9 stacked on the stacked portion 714. The positioning portions 712A and 712B perform positioning of the electrodes 11 and 9 in a direction orthogonal to a direction in which the electrodes 11 and 9 are discharged by the extrusion unit 703. In addition, as described above, the positioning portions 712A and 712B perform positioning of the electrodes 11 and 9 at the time of extracting the partition plates 713A and 713B. The positioning portions 712A and 712B include base bodies 712Aa and 712Ba extending in the vertical direction and pushing portions 712Ab and 712Bb provided at a predetermined pitch in the vertical direction on the base bodies 712Aa and 712Ba. The pushing portion 712Ab of the positioning portion 712A presses a part near an end of the electrodes 11 and 9 close to the wall 711A. The pushing portion 712Bb of the positioning portion 712B presses a part near an end of the electrodes 11 and 9 close to the wall 711B. The positioning portions 712A and 712B include a driving unit (not illustrated) for reciprocating the base bodies 712Aa and 712Ba and the pushing portions 712Ab and 712Bb in a positioning direction. When the positioning portions 712A and 712B perform positioning of the electrodes 11 and 9 stacked on the stacked portion 714, positioning is performed by interposing the electrodes 11 and 9 between the pushing portions 712Ab and 712Bb and the receiving portions 718A and 718B. In a state in which the partition plates 713A and 713B place the electrodes 11 and 9 thereon (state of FIG. 33), a width of the partition plates 713A and 71313 is larger than a dimension of a gap between the pushing portions 712Ab and 712Bb. However, at the time of being extracted, the partition plates 713A and 713B contract in a width direction, and thus become smaller than the dimension of the gap between the pushing portions 712Ab and 712Bb (state of FIG. 32). Such an extension/contraction mechanism can be realized when the respective partition plates 713A and 713B have a configuration of two plates mutually movable in the width direction.

The receiving portions 718A and 718B are members that receive the electrodes 11 and 9 pushed by the pushing portions 712Ab and 712Bb when the positioning portions 712A and 712B perform positioning of the electrodes 11 and 9 stacked on the stacked portion 714. The receiving portions 718A and 718B are disposed on an opposite side of the stacked portion 714 from the positioning portions 712A and 712B. The receiving portions 718A and 718B include columnar members extending in the vertical direction across a plurality of stacked portions 714. The receiving portions 718A and 718B are connected to a driving unit (not illustrated) and can reciprocate in a lateral direction. Therefore, when the stacked body stacked on the stacked portion 714 is taken out, the receiving portions 718A and 718B move in the lateral direction, and thus interference can be avoided.

Next, a description will be given of an operation of the electrode stacking device 700 according to the modification. When the respective supports 702 move to positions of the slits 715A and 715B, the extrusion unit 703 of the positive electrode conveying unit 701A and the extrusion unit 703 of the negative electrode conveying unit 701B simultaneously extrude the electrodes 11 and 9. In this way, the respective electrodes 11 and 9 are simultaneously discharged onto the partition plates 713A and 713B (see a virtual line of FIG. 33). Subsequently, the partition plates 713A and 713B are extracted in a state in which the positioning portions 712A and 712B support the electrodes 11 and 9. In this way, the electrodes 11 and 9 are simultaneously stacked on the stacked portion 714. Each time new electrodes 11 and 9 are added, the stacked portion 714 slightly moves downward by a thickness of these electrodes 11 and 9. Thereafter, the support 702 moves together with the circulating member 706, and the same operation is repeated. The extrusion unit 703 of the positive electrode conveying unit 701A and the extrusion unit 703 of the negative electrode conveying unit 701B simultaneously extrude the electrodes 11 and 9. However, the timing may be shifted.

An electrode stacking device according to an aspect is an electrode stacking device for stacking an electrode supplied by a conveying device and forming an electrode stacked body, the electrode stacking device including an electrode support that receives the electrode supplied by the conveying device and supports the electrode, a circulating member that forms a loop shape extending in the vertical direction and has an outer peripheral surface to which a plurality of electrode supports is attached, a stacked unit disposed on an opposite side from the conveying device with the circulating member interposed therebetween to have stacked portions of a plurality of levels on which electrodes are stacked, and an extrusion portion that simultaneously extrudes electrodes supported by the plurality of electrode supports toward the stacked portions of the plurality of levels, in which the extrusion portion extrudes electrodes at one interval with respect to electrode supports per n levels (where n is an integer of 2 or more).

In such an electrode stacking device, electrodes successively supplied to electrode supports are simultaneously extruded to different stacked portions and stacked thereon. In this way, when electrodes, the number of which is larger than the number of successively supplied electrodes, are simultaneously extruded and stacked, a discharge speed at the time of extruding the electrodes to the stacked portions can be set to be lower than a conveying speed (supply speed) of the electrodes by the conveying device. In this way, it is possible to suppress a position shift of the electrodes during stacking of the electrodes without providing an additional device while preventing a decrease in pace at which the electrodes are stacked. Here, the extrusion portion extrudes electrodes at one interval with respect to electrode supports per n levels. As described above, the extrusion portion can extrude electrodes to a plurality of electrode supports by skipping (n−1) levels. In this way, while an interval at which the electrode supports receive the electrodes can be shortened by reducing a pitch of the electrode supports, the respective electrodes can be accurately discharged to the stacked portions in a state in which a sufficient space is ensured between the simultaneously extruded electrodes on the stacked portion side. In this way, it is possible to further increase the stacking speed while ensuring the stacking accuracy. As described above, according to the electrode stacking device, it is possible to achieve a high stacking speed while suppressing an increase in size of the device.

In an electrode stacking device according to an aspect, the stacked unit may have stacked portions at one interval with respect to electrode supports per n levels. In this case, it is possible to accurately receive an electrode by a stacked portion corresponding to an interval between electrodes extruded by the pressing portion.

In an electrode stacking device according to an aspect, a control unit that controls circulation of the circulating member and an operation of the extrusion portion may be further included, and the control unit may execute a first extrusion operation of extruding in electrodes among the electrodes supported by the electrode supports using the extrusion portion, a first movement operation of moving the circulating member with respect to the extrusion portion in the circulation direction by one level of the electrode supports, and a second extrusion operation of extruding in electrodes using the extrusion portion after the first movement operation and execute a second movement operation of moving the circulating member with respect to the extrusion portion in the circulation direction by {m×n−(n−1)} levels of the electrode supports after executing the first movement operation and the second extrusion operation (n−1) times. In this way, it is possible to smoothly interlock extrusion by the extrusion portion with circulation of the circulating member.

In an electrode stacking device according to an aspect, a pair of conveying units, each of which includes an electrode support, a circulating member, and an extrusion portion, may be provided with the stacked unit interposed therebetween, one of the conveying units may convey a positive electrode obtained by forming a positive electrode active material layer on a surface of a positive electrode current collector, and the other one of the conveying units may convey a negative electrode obtained by forming a negative electrode active material layer on a surface of a negative electrode current collector. In this way, when the conveying units are adopted on both the positive electrode side and the negative electrode side, it is possible to achieve a higher stacking speed of the positive electrode and the negative electrode.

### REFERENCE SIGNS LIST

9: negative electrode (electrode), 11: separator-attached positive electrode (electrode), 14: metal foil (positive electrode current collector), 15: positive electrode active material layer, 16: metal foil (negative electrode current collector), 17: negative electrode active material layer, 200, 300: electrode stacking device, 303: positive electrode supplying conveyor (conveying device), 304: negative electrode supplying conveyor (conveying device), 310, 313: circulating member (mounting member), 311, 314: support (electrode support), 305: stacked unit, 316: stacked portion, 321a, 322a: pushing member (discharge portion), 350: controller, 371A, 371B, 372A, 372B: discharge member (discharge portion), 390: nip roll (discharge portion), 620A, 620B: mounting member.

1. An electrode stacking device for stacking electrodes supplied by a conveying device and forming an electrode stacked body, the electrode stacking device comprising:
an electrode support that receives the electrodes supplied by the conveying device and supports the electrodes;
a mounting member to which a plurality of electrode supports is attached;
a stacked unit having stacked portions of a plurality of levels on which the electrodes are stacked; and
a discharge portion that discharges the electrodes supported by the plurality of electrode supports toward the stacked portions of the plurality of levels,
wherein the discharge portion discharges the electrodes at one interval with respect to the electrode supports per n levels (where n is an integer of 2 or more).

2. The electrode stacking device according to claim 1, wherein the stacked unit has the stacked portions at one interval with respect to the electrode supports per n levels.

3. The electrode stacking device according to claim 1,
wherein the mounting member corresponds to a circulating member having an outer peripheral surface to which the plurality of electrode supports is attached,
the electrode stacking device further comprises
a control unit that controls circulation of the circulating member and an operation of the discharge portion, and
the control unit
executes a first discharge operation of discharging m electrodes among the electrodes supported by the electrode supports using the discharge portion,
a first movement operation of moving the circulating member with respect to the discharge portion in a circulation direction by one level of the electrode supports, and
a second discharge operation of discharging m electrodes using the discharge portion after the first movement operation, and
executes a second movement operation of moving the circulating member with respect to the discharge portion in the circulation direction by {m×n−(n−1)} levels of the electrode supports after executing the first movement operation and the second discharge operation (n−1) times (where m is an integer of 2 or more).

4. The electrode stacking device according to claim 1,
wherein a pair of conveying units, each of which includes the electrode support, the mounting member, and the discharge portion, is provided with the stacked unit interposed therebetween,
one of the conveying units conveys a positive electrode obtained by forming a positive electrode active material layer on a surface of a positive electrode current collector, and
the other one of the conveying units conveys a negative electrode obtained by forming a negative electrode active material layer on a surface of a negative electrode current collector.
